(19) United States
(12) Patent Application Publication
(10) Pub. No.: US 2015/0029969 A1
(43) Pub. Date: Jan. 29, 2015

(54) METHOD AND APPARATUS FOR TRANSMITTING UPLINK SIGNAL IN WIRELESS COMMUNICATION SYSTEM

(71) Applicant: LG ELECTRONICS INC., Seoul (KR)

(72) Inventors: Jonghyun Park, Anyang-si (KR); Kijun Kim, Anyang-si (KR)

(73) Assignee: LG ELECTRONICS INC., Seoul (KR)

(21) Appl. No.: 14/376,596

(22) PCT Filed: Feb. 20, 2013
(86) PCT No.: PCT/KR2013/001327

§ 371 Date: Aug. 4, 2014

Related U.S. Application Data
(60) Provisional application No. 61/600,999, filed on Feb. 20, 2012.

(51) Int. Cl. H04L 5/00; H04B 7/04

(52) U.S. Cl. CPC H04L 5/0048; H04B 7/0452
USPC 370/329

(57) ABSTRACT

The present invention relates to a wireless communication system, and more particularly, to a method and apparatus for transmitting an uplink signal. A method for transmitting an uplink signal at a UE in a wireless communication system includes, when a virtual cell ID for a reference signal for demodulation of a physical uplink channel is provided, generating a sequence of the reference signal on the basis of the virtual cell ID, and transmitting the generated reference signal to an eNB. A sequence shift pattern of the reference signal can be determined on the basis of the virtual cell ID.

### TECHNICAL FIELD

The present description relates to wireless communication, and more specifically, to a method and apparatus for transmitting an uplink signal.

### BACKGROUND ART

To satisfy increasing data throughput in a wireless communication system, MIMO, multi-base station cooperation technology, etc. for increasing throughput of data transmitted in a limited frequency band have been developed.

An enhanced wireless communication system that supports multi-base station cooperative communication through which a plurality of eNBs communicate with user equipments (UEs) using the same time-frequency resource can provide increased data throughput, compared to a conventional wireless communication system in which one eNB communicates with UEs. eNBs participating in cooperative communication may be referred to as cells, antenna ports, antenna port groups, RRHs (Remote Radio Heads), transport points, reception points, access points, etc.

### DISCLOSURE

### Technical Problem

With the introduction of new wireless communication technology, the number of UEs to which an eNB needs to provide a service in a predetermined resource region increases and the quantity of data and control information transmitted/received between the eNBs and UEs to which the eNB provides the service also increases. Since the quantity of radio resource that can be used for the eNB to communicate with the UEs is finite, there is a need for a new method by which the ENB efficiently transmits/receives uplink/downlink data and/or uplink/downlink control information to/from UEs using finite radio resource.

An object of the present invention devised to solve the problem lies on a new method for transmitting an uplink reference signal to support enhanced uplink transmission and a method for successfully receiving the uplink reference signal at an uplink signal receiver.

The technical problems solved by the present invention are not limited to the above technical problems and those skilled in the art may understand other technical problems from the following description.

### TECHNICAL SOLUTION

The object of the present invention can be achieved by providing a method for transmitting an uplink signal at a user equipment (UE) in a wireless communication system, the method including, when a virtual cell ID n_{ID}^{PUSCH} for a reference signal for demodulation of a physical uplink shared channel (PUSCH) is provided, generating a sequence of the reference signal on the basis of n_{ID}^{PUSCH}, and transmitting the generated reference signal to an eNB. A sequence shift pattern fₛₛ^{PUSCH} of the reference signal may be determined according to fₛₛ^{PUSCH}=n_{ID}^{PUSCH} mod 30, and mod denotes a modulo operation.

In another aspect of the present invention, provided herein is a UE device for transmitting an uplink signal, which includes a receiver, a transmitter, and a processor, wherein, when a virtual cell ID n_{ID}^{PUSCH} for a reference signal for demodulation of a PUSCH is provided, the processor is configured to generate a sequence of the reference signal on the basis of n_{ID}^{PUSCH} and to transmit the generated reference signal to an eNB through the transmitter. A sequence shift pattern fₛₛ^{PUSCH} of the reference signal may be determined according to fₛₛ^{PUSCH}=n_{ID}^{PUSCH} mod 30, and mod denotes a modulo operation.

The following may be commonly applied to the above-described embodiments of the present invention.

When n_{ID}^{PUSCH} is not provided, fₛₛ^{PUSCH} may determined according to fₛₛ^{PUSCH}=(N_{ID}^{cell}+Δₛₛ)mod 30, N_{ID}^{cell} may be a physical layer cell ID, Δₛₛ may be set by a higher layer, and Δₛₛε{0, 1, . . . , 29}.

When n_{ID}^{PUSCH} is provided and sequence group hopping for the reference signal is enabled, a pseudo-random sequence generator used to determine a group hopping pattern f_{gh}(nₛ) may be initialized according to

$${c}_{init} = ⌊ \frac{{n}_{ID}^{PUSCH}}{30} ⌋$$

at the start of each radio frame, nₛ may be a slot number and cᵢₙᵢₜ may be an initial value of a pseudo-random sequence.

A sequence group number u of the reference signal may be determined according to an equation of u=(f_{gh}(nₛ)+fₛₛ^{PUSCH})mod 30 with respect to the group hopping pattern f_{gh}(nₛ) and the sequence shift pattern fₛₛ^{PUSCH}.

In addition, uε{0, 1, . . . , 29}.

When n_{ID}^{PUSCH} is provided, sequence group hopping for the reference signal is disabled and sequence hopping is enabled, a pseudo-random sequence generator used to determine a base sequence number v may be initialized according to

$${c}_{init} = ⌊ \frac{{n}_{ID}^{PUSCH}}{30} ⌋ \cdot {2}^{5} + {f}_{ss}^{PUSCH}$$

at the start of each radio frame, and c, may be an initial value of a pseudo-random sequence.

n_{ID}^{PUSCH} may be provided by a higher layer.

n_{ID}^{PUSCH} may be set to a value making the group hopping pattern of the reference signal for the UE identical to a group hopping pattern for other UE which is MU-MIMO (Multi-User-Multiple Input Multiple Output)-paired with the UE.

n_{ID}^{PUSCH} may be set to a value making the sequence shift pattern of the reference signal for the UE identical to a sequence shift pattern for other UE which is MU-MIMO-paired with the UE.

The reference signal may be transmitted on an SC-FDMA (Single Carrier Frequency Division Multiple Access) symbol in a slot in which the PUSCH is transmitted.

The technical problems solved by the present invention are not limited to the above technical problems and those skilled in the art may understand other technical problems from the following description.

### Advantageous Effects

The present invention can provide a new method for transmitting an uplink reference signal to support enhanced uplink transmission and a method for successfully receiving the uplink reference signal at an uplink signal receiver.

The effects of the present invention are not limited to the above-described effects and other effects which are not described herein will become apparent to those skilled in the art from the following description.

### DESCRIPTION OF DRAWINGS

The accompanying drawings, which are included to provide a further understanding of the invention, illustrate embodiments of the invention and together with the description serve to explain the principle of the invention. In the drawings:

FIG. 1 illustrates a radio frame structure;

FIG. 2 illustrates a resource grid;

FIG. 3 illustrates a downlink subframe structure;

FIG. 4 illustrates an uplink subframe structure;

FIG. 5 illustrates a downlink reference signal;

FIGS. 6 to 10 illustrate UCI transmission using PUCCH (Physical Uplink Control Channel) format 1 series, PUCCH format 2 series and PUCCH format 3 series;

FIG. 11 illustrates multiplexing of uplink control information and uplink data in a PUSCH (Physical Uplink Shared Channel) region;

FIG. 12 illustrates an exemplary UL CoMP operation;

FIG. 13 is a flowchart illustrating an uplink reference signal transmission method according to an embodiment of the present invention; and

FIG. 14 shows configurations of an eNB and a UE according to an embodiment of the present invention.

### BEST MODE

Embodiments described hereinbelow are combinations of elements and features of the present invention. The elements or features may be considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged. Some constructions of any one embodiment may be included in another embodiment and may be replaced with corresponding constructions of another embodiment.

In the embodiments of the present invention, a description is made, centering on a data transmission and reception relationship between a base station (BS) and a User Equipment (UE). The BS is a terminal node of a network, which communicates directly with a UE. In some cases, a specific operation described as performed by the BS may be performed by an upper node of the BS.

Namely, it is apparent that, in a network comprised of a plurality of network nodes including a BS, various operations performed for communication with a UE may be performed by the BS, or network nodes other than the BS. The term ‘BS’ may be replaced with the term ‘fixed station’, ‘Node B’, ‘evolved Node B (eNode B or eNB)’, ‘Access Point (AP)’, etc. The term ‘UE’ may be replaced with the term ‘terminal’, ‘Mobile Station (MS)’, ‘Mobile Subscriber Station (MSS)’, ‘Subscriber Station (SS)’, etc.

Specific terms used for the embodiments of the present invention are provided to aid in understanding of the present invention. These specific terms may be replaced with other terms within the scope and spirit of the present invention.

In some cases, to prevent the concept of the present invention from being ambiguous, structures and apparatuses of the known art will be omitted, or will be shown in the form of a block diagram based on main functions of each structure and apparatus. Also, wherever possible, the same reference numbers will be used throughout the drawings and the specification to refer to the same or like parts.

The embodiments of the present invention can be supported by standard documents disclosed for at least one of wireless access systems, Institute of Electrical and Electronics Engineers (IEEE) 802, 3^{rd} Generation Partnership Project (3GPP), 3GPP Long Term Evolution (3GPP LTE), LTE-Advanced (LTE-A), and 3GPP2. Steps or parts that are not described to clarify the technical features of the present invention can be supported by those documents. Further, all terms as set forth herein can be explained by the standard documents.

Techniques described herein can be used in various wireless access systems such as Code Division Multiple Access (CDMA), Frequency Division Multiple Access (FDMA), Time Division Multiple Access (TDMA), Orthogonal Frequency Division Multiple Access (OFDMA), Single Carrier-Frequency Division Multiple Access (SC-FDMA), etc. CDMA may be implemented as a radio technology such as Universal Terrestrial Radio Access (UTRA) or CDMA2000. TDMA may be implemented as a radio technology such as Global System for Mobile communications (GSM)/General Packet Radio Service (GPRS)/Enhanced Data Rates for GSM Evolution (EDGE). OFDMA may be implemented as a radio technology such as IEEE 802.11 (Wi-Fi), IEEE 802.16 (WiMAX), IEEE 802.20, Evolved-UTRA (E-UTRA) etc. UTRA is a part of Universal Mobile Telecommunication System (UMTS). 3GPP LTE is a part of Evolved UMTS (E-UMTS) using E-UTRA. 3GPP LTE employs OFDMA for downlink and SC-FDMA for uplink. LTE-A is an evolution of 3GPP LTE. WiMAX can be described by the IEEE 802.16e standard (Wireless Metropolitan Area Network (WirelessMAN-OFDMA Reference System) and the IEEE 802.16m standard (WirelessMAN-OFDMA Advanced System). For clarity, this application focuses on the 3GPP LTE/LTE-A system. However, the technical features of the present invention are not limited thereto.

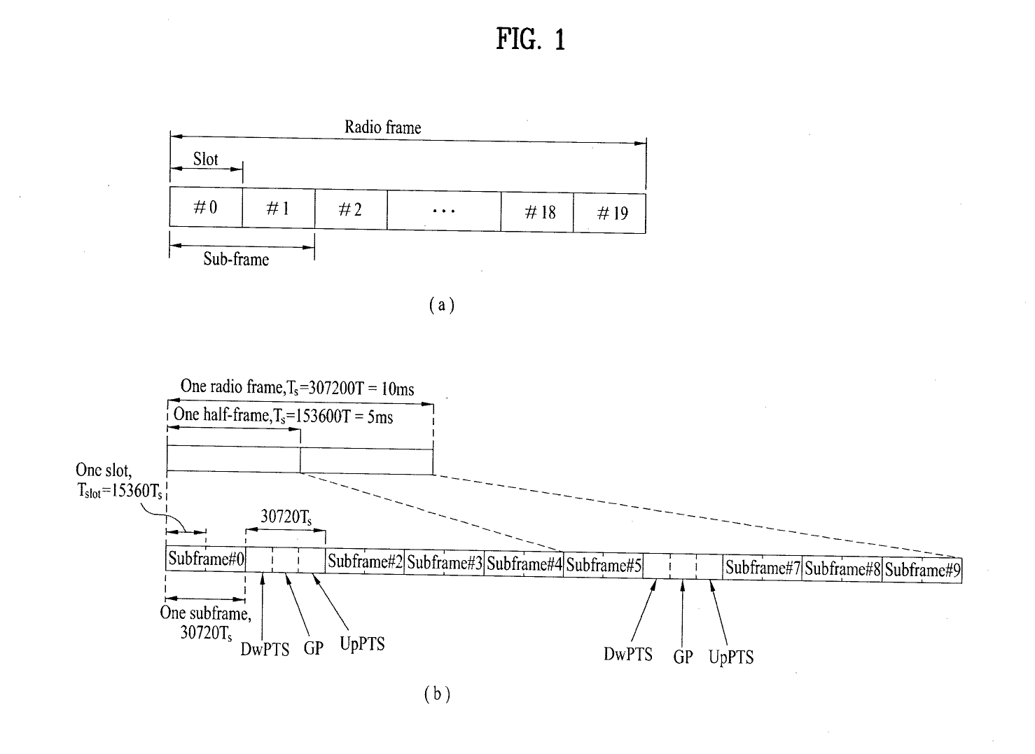

A radio frame structure of 3GPP LTE is described with reference to FIG. 1.

In a cellular orthogonal frequency division multiplex (OFDM) wireless packet communication system, uplink/downlink data packet transmission is performed on a subframe basis and a subframe is defined as a predetermined time period including a plurality of OFDM symbols. 3GPP LTE supports a type 1 radio frame structure applicable to frequency division duplex (FDD) and a type 2 radio frame structure applicable to time division duplex (TDD).

FIG. 1(a) illustrates the type 1 radio frame structure. A radio frame is divided into 10 subframes. Each subframe is further divided into two slots in the time domain. A unit time during which one subframe is transmitted is defined as a transmission time interval (TTI). For example, one subframe may be 1 ms in duration and one slot may be 0.5 ms in duration. A slot may include a plurality of OFDM symbols in the time domain and a plurality of resource blocks in the frequency domain. Because 3GPP LTE adopts OFDMA for downlink, an OFDM symbol represents one symbol period. An OFDM symbol may be referred to as an SC-FDMA symbol or symbol period. A resource block (RB) is a resource allocation unit including a plurality of contiguous subcarriers in a slot.

The number of OFDM symbols included in one slot may be changed according to the configuration of a cyclic prefix (CP). The CP includes an extended CP and a normal CP. For example, if the OFDM symbols are configured by the normal CP, the number of OFDM symbols included in one slot may be seven. If the OFDM symbols are configured by the extended CP, since the length of one OFDM symbol is increased, the number of OFDM symbols included in one slot is less than that of the case of the normal CP. In case of the extended CP, for example, the number of OFDM symbols included in one slot may be six. If the channel state is unstable, for example, if a UE moves at a high speed, the extended CP may be used in order to further reduce interference between symbols.

FIG. 1(b) illustrates the type 2 radio frame structure. The type 2 radio frame includes two half-frames, each of which is made up of five subframes, a downlink pilot time slot (DwPTS), a guard period (GP), and an uplink pilot time slot (UpPTS), in which one subframe consists of two slots. DwPTS is used to perform initial cell search, synchronization, or channel estimation. UpPTS is used to perform channel estimation of a base station and uplink transmission synchronization of a UE. The guard interval (GP) is located between an uplink and a downlink so as to remove interference generated in the uplink due to multi-path delay of a downlink signal. One subframe is composed of two slots irrespective of the radio frame type.

The radio frame structure is purely exemplary and thus the number of subframes in a radio frame, the number of slots in a subframe, or the number of symbols in a slot may vary.

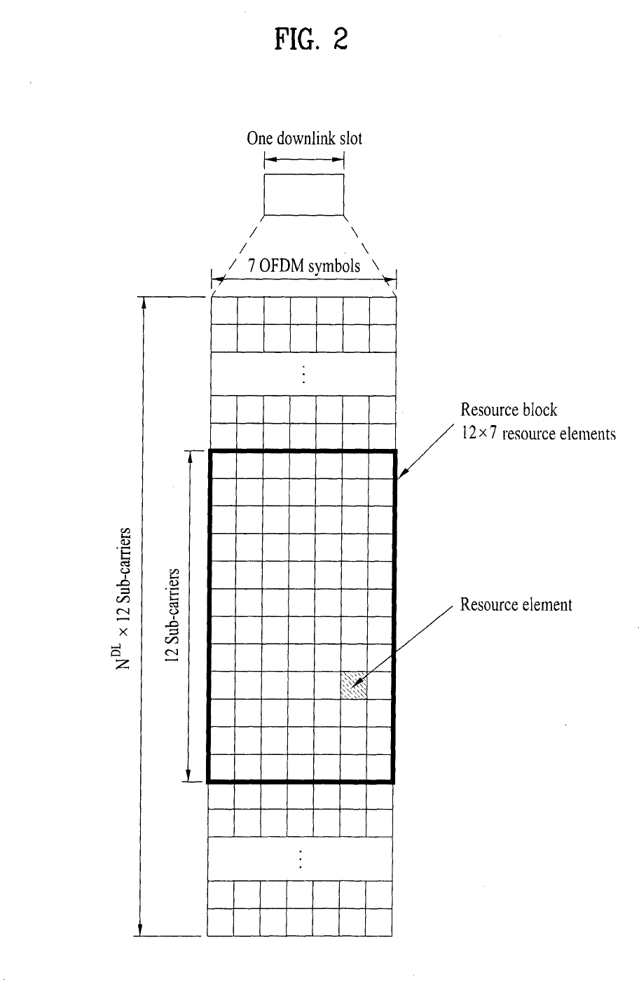

FIG. 2 illustrates a resource grid in a downlink slot. A downlink slot includes 7 OFDM symbols in the time domain and an RB includes 12 subcarriers in the frequency domain, which does not limit the scope and spirit of the present invention. For example, a downlink slot includes 7 OFDM symbols in case of a normal CP, whereas a downlink slot includes 6 OFDM symbols in case of an extended CP. Each element of the resource grid is referred to as a resource element (RE). An RB includes 12×7 REs. The number of RBs in a downlink slot, N^{DL} depends on a downlink transmission bandwidth. An uplink slot may have the same structure as a downlink slot.

Downlink Subframe Structure

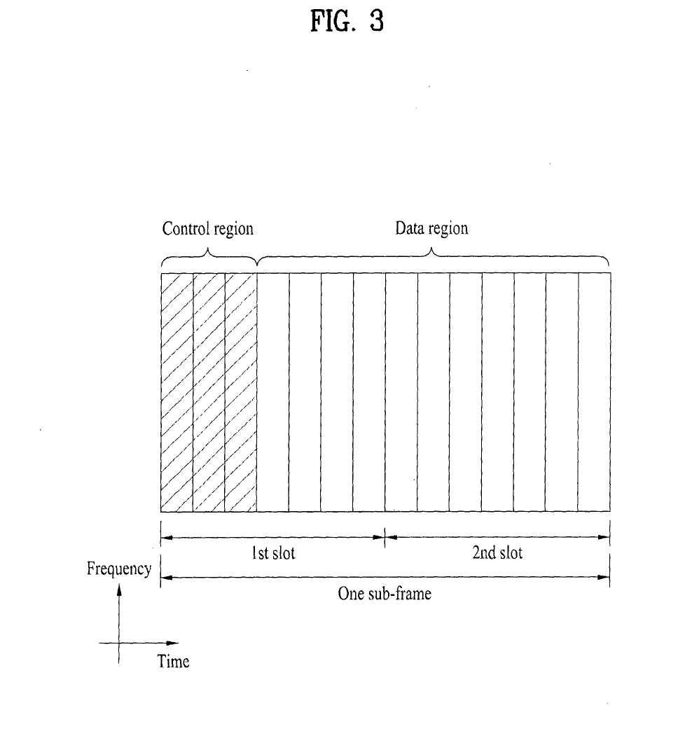

FIG. 3 illustrates a downlink subframe structure. Up to three OFDM symbols at the start of the first slot in a downlink subframe correspond to a control region to which control channels are allocated and the other OFDM symbols of the downlink subframe correspond to a data region to which a physical downlink shared channel (PDSCH) is allocated. Downlink control channels used in 3GPP LTE include a physical control format indicator channel (PCFICH), a physical downlink control channel (PDCCH), and a physical hybrid automatic repeat request (HARQ) indicator channel (PHICH). The PCFICH is located in the first OFDM symbol of a subframe, carrying information about the number of OFDM symbols used for transmission of control channels in the subframe. The PHICH delivers an HARQ acknowledgmentnegative acknowledgment (ACK/NACK) signal in response to an uplink transmission. Control information carried on the PDCCH is called downlink control information (DCI). The DCI transports uplink or downlink scheduling information, or uplink transmission power control commands for UE groups. The PDCCH delivers information about resource allocation and a transport format for a downlink shared channel (DL-SCH), resource allocation information about an uplink shared channel (UL-SCH), paging information of a paging channel (PCH), system information on the DL-SCH, information about resource allocation for a higher-layer control message such as a random access response transmitted on the PDSCH, a set of transmission power control commands for individual UEs of a UE group, transmission power control information, voice over Internet protocol (VoIP) activation information, etc. A plurality of PDCCHs may be transmitted in the control region. A UE may monitor a plurality of PDCCHs. A PDCCH is formed by aggregation of one or more consecutive control channel elements (CCEs). A CCE is a logical allocation unit used to provide a PDCCH at a coding rate based on the state of a radio channel. A CCE includes a set of REs. The format of a PDCCH and the number of available bits for the PDCCH are determined according to the correlation between the number of CCEs and a coding rate provided by the CCEs. An eNB determines the PDCCH format according to DCI transmitted to a UE and adds a cyclic redundancy check (CRC) to control information. The CRC is masked by an identifier known as a radio network temporary identifier (RNTI) according to the owner or usage of the PDCCH. If the PDCCH is directed to a specific UE, its CRC may be masked by a cell-RNTI (C-RNTI) of the UE. If the PDCCH carries a paging message, the CRC of the PDCCH may be masked by a paging indicator identifier (P-RNTI). If the PDCCH carries system information, particularly, a system information block (SIB), its CRC may be masked by a system information ID and a System Information RNTI (SI-RNTI). To indicate that the PDCCH carries a random access response in response to a random access preamble transmitted by a UE, its CRC may be masked by a random access-RNTI (RA-RNTI).

Downlink Reference Signal

When a packet is transmitted in a wireless communication system, signal distortion may occur during transmission because the packet is transmitted through a radio channel. To successfully receive a distorted signal at a receiver, it is necessary to correct distortion of the received signal using channel information. To detect the channel information, a method of transmitting a signal known to a transmitter and the receiver and detecting the channel information using a degree of distortion when the signal is received through the channel is widely used. The signal is called a pilot signal or a reference signal.

In transmission and reception of data using multiple antennas, the receiver needs to know channel states between transmit antennas and receive antennas to successfully receive a signal. Accordingly, a separate reference signal is needed for each transmit antenna.

Downlink reference signals include a common reference signal (CRS) shared by all UEs in a cell and a dedicated reference signal (DRS) for only a specific UE. Information for channel estimation and demodulation can be provided according to these reference signals. The CRS is used to estimate a channel of a physical antenna, can be commonly received by all UEs in a cell, and is distributed in the overall band. The CRS can be used for acquisition of channel state information (CSI) and data demodulation.

A receiver (UE) can estimate a channel state from the CRS and feed back indicators regarding channel quality, such as a channel quality indicator (CQI), a precoding matrix index (PMI) and/or a rank indicator (RI), to a transmitter (eNB). The CRS may be called a cell-specific reference signal.

The DRS can be transmitted through a corresponding RE when demodulation of data on a PDSCH is needed. The UE may receive information about presence or absence of a DRS from a higher layer and receive information representing that the DRS is valid only when a corresponding PDSCH is mapped. The DRS may also be called a UE-specific reference signal or modulation reference signal (DMRS). The DRS (or UE-specific reference signal) is used for data demodulation. A precoding weight used for a specific UE is used for the DRS during multi-antenna transmission such that an equivalent channel corresponding a combination of a precoding weight transmitted through each transmit antenna and a transmission channel can be estimated when the UE receives the DRS.

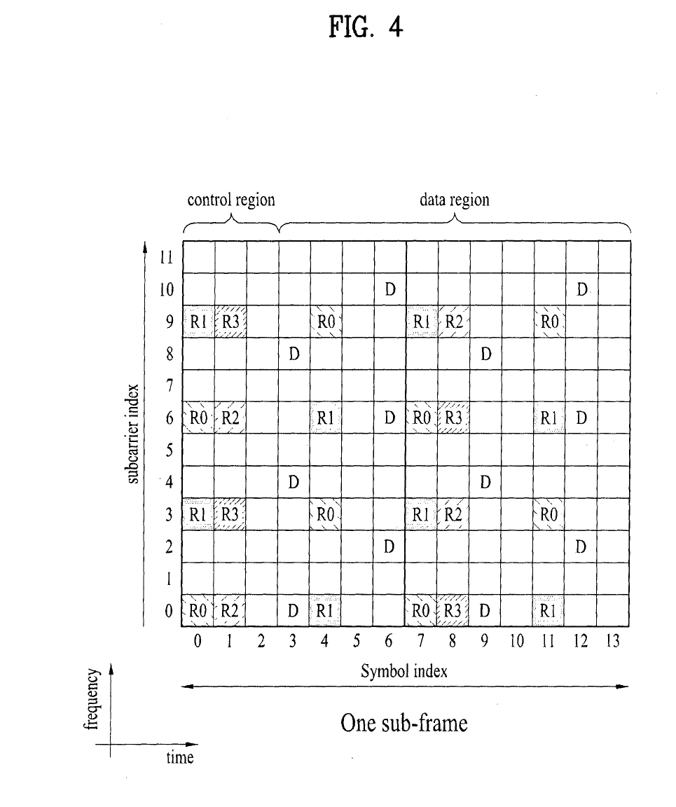

FIG. 4 illustrates a pattern of matching a CRS and a DRS defined in 3GPP LTE to a downlink RB pair. A downlink RB pair as a unit to which a reference signal is mapped can be represented by a product of one subframe in the time domain and 12 subcarriers in the frequency domain. That is, one RB pair has a length corresponding to 14 OFDM symbols in case of normal CP and a length corresponding to 12 OFDM symbols in case of extended CP. FIG. 4 shows an RB pair in case of normal CP.

FIG. 4 shows positions of reference signals on an RB pair in a system in which an eNB supports four transmit antennas. In FIG. 4, REs denoted by ‘R0’, ‘R1’, ‘R2’ and ‘R3’ correspond to CRS positions for antenna port indexes 0, 1, 2 and 3. REs denoted by ‘D’ correspond to DRS positions.

High-order MIMO (Multiple Input Multiple Output), multi-cell transmission, enhanced multi-user (MU)-MIMO, etc. are considered in LTE-A evolved from 3GPP LTE. To efficiently operate reference signals and support enhanced transmission schemes, DRS based data demodulation is being considered. That is, a DRS (or UE-specific reference signal or DMRS) for two or more layers can be defined to support data transmission through an additional antenna, separately from a DRS (corresponding to antenna port index 5) for rank 1 beamforming defined in 3GPP LTE (e.g. release-8). For example, UE-specific reference signal ports supporting up to 8 transmit antenna ports can be defined as antenna port numbers 7 to 12 and can be transmitted in REs which do not overlap with other reference signals.

Furthermore, LTE-A may separately define an RS related to feedback of channel state information (CSI) such as CQI/PMI/RI for a new antenna port as a CSI-RS. For example, CSI-RS ports supporting up to 8 transmit antenna ports can be defined as antenna port numbers 15 to 22 and can be transmitted in REs which do not overlap with other reference signals.

Uplink Subframe Structure

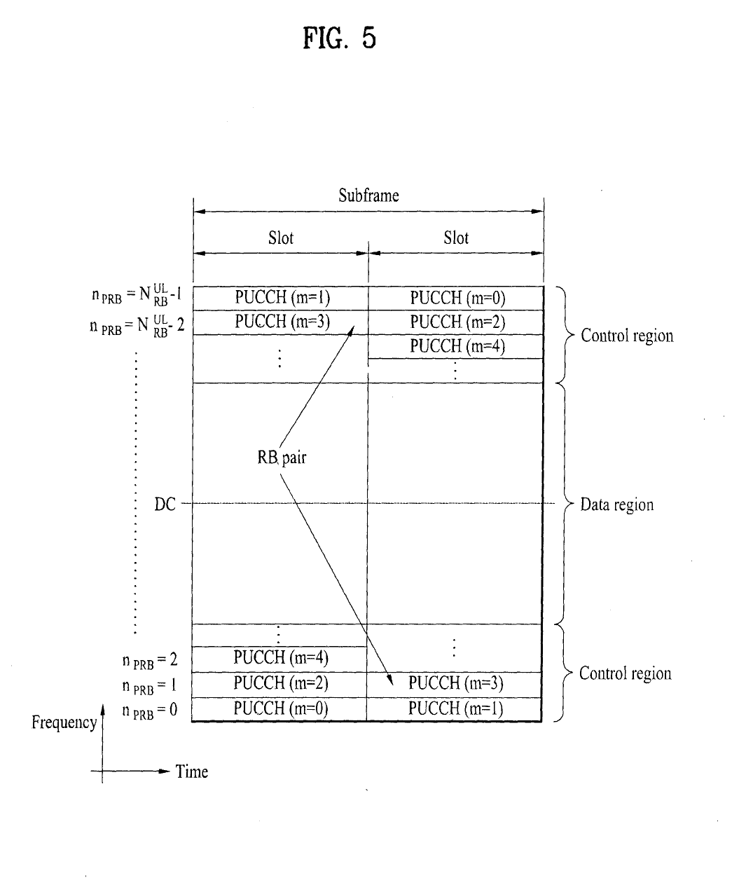

FIG. 5 illustrates an uplink subframe structure.

Referring to FIG. 5, an uplink subframe may be divided into a control region and a data region in the frequency domain. One or more Physical Uplink Control Channels (PUCCHs) carrying uplink control information may be allocated to the control region and one or more Physical Uplink Shared Channels (PUSCHs) carrying user data may be allocated to the data region.

Subcarriers far from a direct current (DC) subcarrier are used for the control region in the UL subframe. In other words, subcarriers at both ends of an uplink transmission bandwidth are allocated for transmission of uplink control information. The DC subcarrier is a component that is spared from signal transmission and mapped to carrier frequency f₀ during frequency upconversion. A PUCCH from one UE is allocated to an RB pair in a subframe and the RBs of the RB pair occupy different subcarriers in two slots. This PUCCH allocation is called frequency hopping of an RB pair allocated to a PUCCH over a slot boundary. However, if frequency hopping is not applied, the RB pair occupies the same subcarriers.

A PUCCH may be used to transmit the following control information.
SR (Scheduling Request): used to request UL-SCH resource. This information is transmitted using OOK (On-Off Keying).
HARQ-ACK: response to a PDCCH and/or a response to a downlink data packet (e.g. codeword) on a PDSCH. This information represents whether the PDCCH or PDSCH has been successfully received. 1-bit HARQ-ACK is transmitted in response to a single downlink codeword and 2-bit HARQ-ACK is transmitted in response to two downlink codewords. HARQ-ACK responses include positive ACK (simply, ACK), negative ACK (NACK), DTX (Discontinuous Transmission) and NACK/DTX. Here, the term HARQ-ACK is used with HARQ ACK/NACK and ACK/NACK.
CSI (Channel State Information): This is feedback information about a downlink channel. MIMO-related feedback information includes an RI and a PMI.

The quantity of UCI that can be transmitted by a UE in a subframe depends on the number of SC-FDMA symbols available for control information transmission. SC-FDMA symbols available for UCI correspond to SC-FDMA symbols other than SC-FDMA symbols used for reference signal transmission in a subframe. In the case of a subframe including a sounding reference signal (SRS), the SC-FDMA symbols available for UCI correspond to SC-FDMA symbols other than SC-FDMA symbols used for reference signal transmission and the last SC-FDMA symbol in the subframe. A reference signal is used for PUCCH coherent detection. A PUCCH supports various formats according to transmitted information.

PUCCH format 1 is used to transmit SR, PUCCH format 1a/1b is used to transmit ACK/NACK information, and PUCCH format 2 is used to carry CSI such as CQI/PMI/RI. PUCCH format 2a/2b is used to carry ACK/NACK information with CSI and PUCCH format 3 series is used to transmit ACK/NACK information.

UCI Transmission

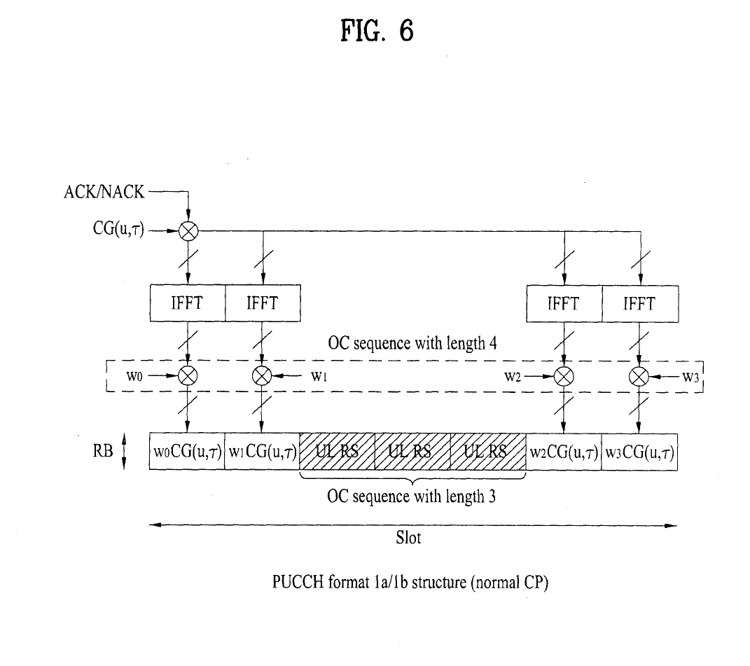

FIGS. 6 to 10 illustrate UCI transmission using PUCCH format 1 series, PUCCH format 2 series and PUCCH format 3 series.

In 3GPP LTE/LTE-A, a subframe having a normal CP is composed of two slots each of which includes seven OFDM symbols (or SC-FDMA symbols). A subframe having an extended CP is composed of two slots each of which includes six OFDM symbols (or SC-FDMA symbols). Since the number of OFDM symbols (or SC-FDMA symbols) per subframe depends on a CP length, a PUCCH transmission structure in a UL subframe is varied according to CP length. Accordingly, a method of transmitting UCI in a UL subframe by a UE is varied according to PUCCH format and CP length.

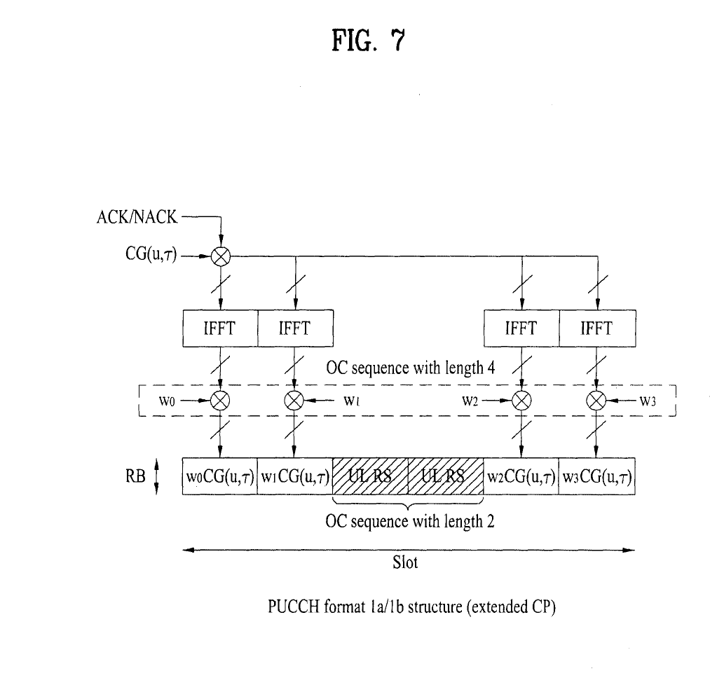

Referring to FIGS. 6 and 7, in case of transmission using PUCCH formats 1a and 1b, the same control information is repeated on a slot basis in a subframe. UEs transmit ACK/NACK signals through different resources composed of different cyclic shifts (CSs) of a CG-CAZAC (Computer-Generated Constant Amplitude Zero Auto Correlation) sequence and orthogonal cover codes (OCC). A CS may correspond to a frequency domain code and an OCC may correspond to a time domain spreading code. An OCC may also be called an orthogonal sequence. An OCC includes a Walsh/DFT (Discrete Fourier Transform) orthogonal code, for example. When the number of CSs is 6 and the number of OCCs is 3, a total of 18 PUCCHs can be multiplexed in the same PRB (Physical Resource Block) on the basis of a single antenna port. An orthogonal sequence w₀, w₁, w₂ and w₃ may be applied in a time domain after FFT (Fast Fourier Transform) or in a frequency domain before FFT. A PUCCH resource for ACK/NACK transmission in 3GPP LTE/LTE-A is represented by a combination of the position of a time-frequency resource (e.g. PRB), a cyclic shift of a sequence for frequency spreading and an orthogonal code (or quasi-orthogonal code) for time spreading. Each PUCCH resource is indicated using a PUCCH resource index (PUCCH index). A slot level structure of PUCCH format 1 series for SR transmission is identical to that of PUCCH formats 1a and 1b and a modulation method thereof is different.

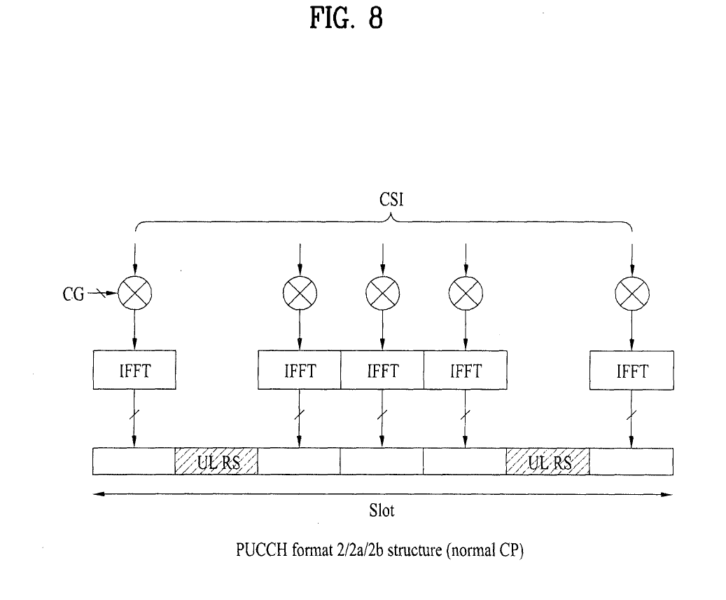

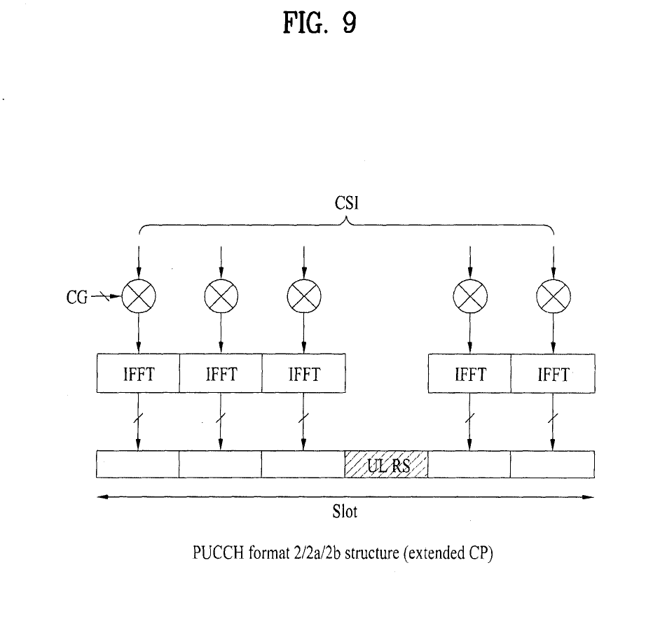

FIG. 8 illustrates transmission of CSI in a UL slot having a normal CP using PUCCH format 2a/2b/2c and FIG. 9 illustrates transmission of CSI in a UL slot having an extended CP using PUCCH format 2a/2b/2c.

Referring to FIGS. 8 and 9, in case of the normal CP, a UL subframe is composed of 10 SC-FDMA symbols excepting symbols carrying UL reference signals (RSs). CSI is coded into 10 transmission symbols (which may be called complex-valued modulation symbols) through block coding. The 10 transmission symbols are respectively mapped to 10 SC-FDMA symbols and transmitted to an eNB.

PUCCH format 1/1a/1b and PUCCH format 2/2a/2b can carry only UCI having up to a predetermined number of bits. However, as the quantity of UCI increases due to introduction of carrier aggregation, a TDD system, a relay system and a multi-node system and an increase in the number of antennas, a PUCCH format, which is called PUCCH format 3, capable of carrying a larger quantity of UCI than PUCCH formats 1/1a/1b/2/2a/2b, is introduced. For example, PUCCH format 3 can be used for a UE for which carrier aggregation is set to transmit a plurality of ACK/NACK signals for a plurality of PDSCHs, received from an eNB through a plurality of downlink carriers, through a specific uplink carrier.

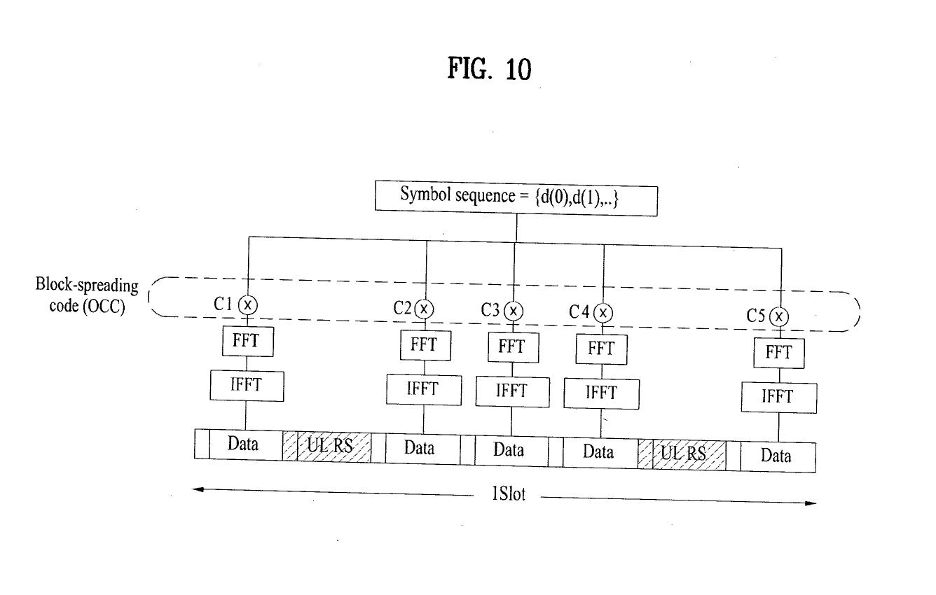

PUCCH format 3 may be configured on the basis of block spreading, for example. Referring to FIG. 10, block spreading time-domain-spreads a symbol sequence using an OCC (or orthogonal sequence) and transmits the spread symbol sequence. According to block spreading, control signals of a plurality of UEs can be multiplexed to the same RB and transmitted to an eNB. In the case of PUCCH format 2, one symbol sequence is transmitted over the time domain, and UCI of UEs is multiplexed using a CS of a CAZAC sequence and transmitted to an eNB. In the case of a new PUCCH format based on block spreading (e.g. PUCCH format 3), one symbol sequence is transmitted over the frequency domain, and UCI of UEs is multiplexed using OCC based time-domain spreading and transmitted to the eNB. Referring to FIG. 8, one symbol sequence is spread using an OCC having length-5 (that is, SF=5) and mapped to 5 SC-FDMA symbols. While FIG. 10 illustrates a case in which two RS symbols are used in one slot, 3 RS symbols may be used and an OCC with SF=4 can be used for symbol sequence spreading and UE multiplexing. Here, the RS symbols can be generated from a CAZAC sequence having a specific CS. A specific OCC can be applied to/multiplied by the RS symbols and then the RS symbols can be transmitted to the eNB. In FIG. 10, DFT may be applied prior to OCC, and FFT (Fast Fourier Transform) may replace DFT.

In FIGS. 6 to 10, a UL RS transmitted with UCI on a PUCCH can be used for the eNB to demodulate the UCI.

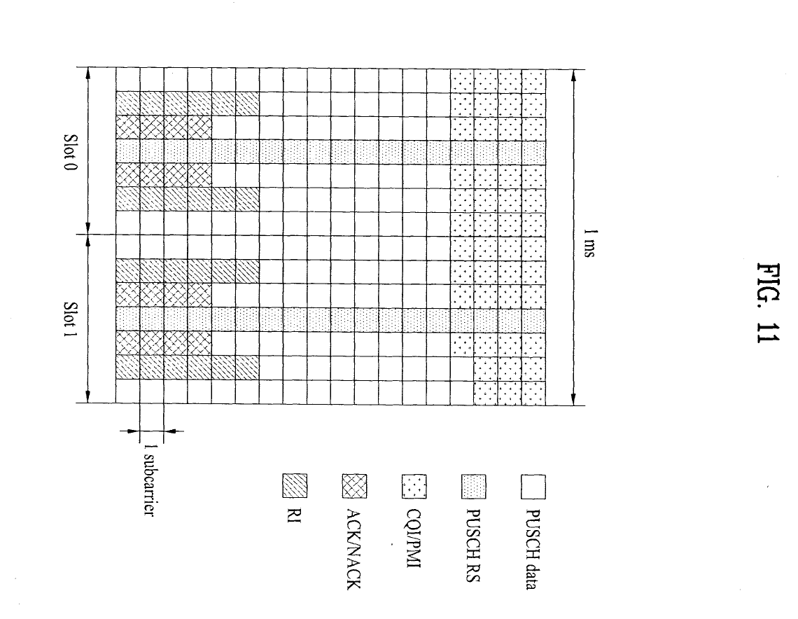

FIG. 11 illustrates multiplexing of UCI and uplink data in a PUSCH region.

The uplink data can be transmitted in a data region of a UL subframe through a PUSCH. A UL DMRS (Demodulation Reference Signal) corresponding to an RS for demodulation of the uplink data can be transmitted with the uplink data in the data region of the UL subframe. The control region and the data region in the UL subframe are respectively called a PUCCH region and a PUSCH region.

When UCI needs to be transmitted in a subframe to which PUSCH transmission is assigned, a UE multiplexes the UCI and uplink data (referred to as PUSCH data hereinafter) prior to DFT-spreading and transmits the multiplexed UL signal over a PUSCH if simultaneous transmission of the PUSCH and a PUCCH is not allowed. The UCI includes at least one of CQI/PMI, HARQ ACK/NACK and RI. The number of REs used to transmit each of CQI/PMI, HARQ ACK/NACK and RI is based on a modulation and coding scheme (MCS) and an offset value (Δ_{offset}^{CQI}, Δ_{offset}^{HARQ-ACK}, Δ_{offset}^{RI}) allocated for PUSCH transmission. The offset value allows different coding rates according to UCI and is semi-statically set through higher layer (e.g. radio resource control (RRC)) signaling. The PUSCH data and UCI are not mapped to the same RE. The UCI is mapped such that it is present in both slots of the subframe.

Referring to FIG. 11, CQI and/or PMI resource is located at the start of the PUSCH data, sequentially mapped to all SC-FDMA symbols in one subcarrier and then mapped to the next subcarrier. The CQI/PMI is mapped to a subcarrier from the left to the right, that is, in a direction in which the SC-FDMA symbols index increases. The PUSCH data is rate-matched in consideration of the quantity of a CQI/PMI resource (that is, the number of coded symbols). The same modulation order as that of UL-SCH data is used for the CQI/PMI. ACK/NACK is inserted into part of SC-FDMA resource to which the UL-SCH data is mapped through puncturing. The ACK/NACK is located beside a PUSCH RS for demodulation of the PUSCH data and sequentially occupies corresponding SC-FDMA symbols from bottom to top, that is, in a direction in which the subcarrier index increases. In a normal CP case, SC-FDMA symbols for the ACK/NACK correspond to SC-FDMA symbols #2/#5 in each slot, as shown in FIG. 11. Coded RI is located beside a symbol for ACK/NACK irrespective of whether the ACK/NACK is actually transmitted in the subframe.

In 3GPP LTE, UCI may be scheduled such that it is transmitted over a PUSCH without PUSCH data. Multiplexing ACK/NACK, RI and CQI/PMI is similar to that illustrated in FIG. 11. Channel coding and rate matching for control signaling without PUSCH data correspond to those for the above-described control signaling having PUSCH data.

In FIG. 11, the PUSCH RS can be used to demodulate the UCI and/or the PUSCH data transmitted in the PUSCH region. In the present invention, a UL RS related to PUCCH transmission and a PUSCH RS related to PUSCH transmission are commonly called a DMRS.

A sounding reference signal (SRS) (not shown) may be allocated to the PUSCH region. The SRS is a UL RS that is not related to transmission of a PUSCH or PUCCH. The SRS is transmitted on the last SC-FDMA symbol of a UL subframe in the time domain and transmitted in a data transmission band of the UL subframe, that is, a PUSCH region in the frequency domain. An eNB can measure an uplink channel state between a UE and the eNB using the SRS. SRSs of a plurality of UEs, which are transmitted/received on the last SC-FDMA symbol of the same subframe, can be discriminated according to frequency positions/sequences thereof

Uplink Reference Signal

A DMRS transmitted in a PUCCH region and a DMRS and an SRS transmitted in a PUSCH region can be regarded as uplink UE-specific RSs because they are UE-specifically generated by a specific UE and transmitted to an eNB.

A UL RS is defined by a cyclic shift of a base sequence according to a predetermined rule. For example, an RS sequence r_{u,v}^{(α)}(n) is defined by a cyclic shift α of a base sequence r_{u,v}(n) according to the following equation.

r_{u,v}^{(α)}(n)=e^{rαn}·r_{u,v}(n),0≦n<M_{sc}^{RS} [Equation 1]

Here, M_{sc}^{RS} is the length of the RS sequence, M_{sc}^{RS}=m·N_{sc}^{RB} and 1≦m≦N_{RB}^{max,UL}. N_{RB}^{max,UL} represented by a multiple of N_{sc}^{RB} refers to a widest uplink bandwidth configuration. N_{sc}^{RB} denotes the size of an RB and is represented by the number of subcarriers. A plurality of RS sequences can be defined from a base sequence through different cyclic shift values α. A plurality of base sequences is defined for a DMRS and an SRS. For example, the base sequences are defined using a root Zadoff-Chu sequence. Base sequences r_{u,v}(n) are divided into two groups each of which includes one or more base sequences. For example, each base sequence group can include one base sequence having a length of M_{sc}^{RS}=m·N_{sc}^{RB} (1≦m≦5) and two base sequences having a length of M_{sc}^{RS}=m·N_{sc}^{RB} (6≦m≦N_{sc}^{RB}). As to r_{u,v}(n), uε{0, 1, . . . , 29} denotes a group number (that is, group index) and v denotes a base sequence number (that is, base sequence index) in the corresponding group. Each base sequence group number and a base sequence number in the corresponding group may be varied with time.

The sequence group number u in a slot nₛ is defined by a group hopping pattern f_{gh}(nₛ) and a sequence shift pattern fₛₛ according to the following equation.

u=(f_{gh}(nₛ)+fₛₛ)mod 30 [Equation 2]

In Equation 2, mod refers to a modulo operation. A mod B means a remainder obtained by dividing A by B.

A plurality of different hopping patterns (e.g. 30 hopping patterns) and a plurality of different sequence shift patterns (e.g. 17 sequence shift patterns) are present. Sequence group hopping may be enabled or disabled according to a cell-specific parameter provided by a higher layer.

The group hopping pattern f_{gh}(nₛ) can be provided by a PUSCH and a PUCCH according to the following equation.

$${f}_{gh} ( {n}_{S} ) = \{ \begin{matrix}0 & if group hopping is disabled \\ ( {Σ}_{i = 0}^{7} c ( 8 {n}_{S} + i ) \cdot {2}^{i} ) mod 30 & if group hopping is enabled \end{matrix} \qquad [ Equation 3 ]$$

Here, a pseudo-random sequence c(i) can be defined by a length-31 Gold sequence. An output sequence c(n) (n=0, 1, . . . , M_{PN}−1) having a length of M_{PN} is defined according to the following equation.

c(n)=(x₁(n+N_{C})+x₂(n+N_{C}))mod 2

x₁(n+31)=(x₁(n+3)+x₁(n))mod 2

x₂(n+31)=(x₂(n+3)+x₂(n+2)+x₂(n+1)+x₂(n))mod 2 [Equation 4]

Here, N_{C}=1600 and the first m-sequence is initialized to x₁(0)=1, x₁(n)=0, n=1, 2, . . . , 30. Initialization of the second m-sequence is represented by the following equation having a value depending on application of the sequence.

cᵢₙᵢₜ=Σᵢ₌₀³⁰x₂(i)·2ⁱ [Equation 5]

In Equation 3, a pseudo-random sequence generator is initialized to cᵢₙᵢₜ at the start of each radio frame according to the following equation.

$${c}_{init} = ⌊ \frac{{N}_{ID}^{cell}}{30} ⌋ \qquad [ Equation 6 ]$$

In Equation 6, └ ┘ denotes floor operation and └A┘ is a maximum integer less than or equal to A.

According to 3GPP LTE, a PUCCH and a PUSCH have different sequence shift patterns although they have the same group hopping pattern according to Equation 3. A sequence shift pattern fₛₛ^{PUCCH} for the PUCCH is provided on the basis of cell identification information (cell ID) according to the following equation.

fₛₛ^{PUCCH}=N_{ID}^{cell} mod 30 [Equation 7]

A sequence shift pattern fₛₛ^{PUSCH} for the PUSCH is given according to the following equation using the sequence shift pattern fₛₛ^{PUCCH} for the PUCCH and a value Δₛₛ configured by a higher layer.

fₛₛ^{PUSCH}=(fₛₛ^{PUCCH}+Δₛₛ)mod 30 [Equation 8]

Here, Δₛₛε{0, 1, . . . , 29}.

Base sequence hopping is applied only to RSs having a length of M_{sc}^{RS}≧6N_{sc}^{RB}. For RSs having a length of M_{sc}^{RS}≧6N_{sc}^{RB}, the base sequence number v in a base sequence group is 0. For RSs having a length of M_{sc}^{RS}≧6N_{sc}^{RB}, the base sequence number v in a base sequence group in the slot nₛ is defined as v=c(nₛ) when group hopping is disabled and sequence hopping is enabled and defined as v=0 in other cases. Here, the pseudo-random sequence c(i) is given by Equation 4. The pseudo-random sequence generator is initialized to cᵢₙᵢₜ at the start of each radio frame according to the following equation.

$${c}_{init} = ⌊ \frac{{N}_{ID}^{cell}}{30} ⌋ \cdot {2}^{5} + {f}_{ss}^{PUSCH} \qquad [ Equation 9 ]$$

A sequence r_{PUCCH}^{(p)}(•) of the UL RS (PUCCH DMRS) in FIGS. 6 to 10 is given by the following equation.

$${r}_{PUCCH}^{( p )} ( {m}^{′} {N}_{RS}^{PUCCH} {M}_{sc}^{RS} + {mM}_{sc}^{RS} + n ) = \frac{1}{\sqrt{P}} {\overline{w}}^{( p )} ( m ) z ( m ) {r}_{u , v}^{( α\_ p )} ( n ) \qquad [ Equation 10 ]$$

Here, m=0, . . . , N_{RS}^{PUCCH}−1, n=0, . . . , M_{sc}^{RS}−1, and m′=0, 1. N_{RS}^{PUCCH} denotes the number of reference symbols per slot for the PUCCH and P denotes the number of antenna ports used for PUCCH transmission. A sequence r_{u,v}^{(α}^{_{—}}^{p)}(n) is given by Equation 1 having M_{sc}^{RS}=12, and a cyclic shift α_p is determined by a PUCCH format.

All PUCCH formats use a cell-specific CS, n_{cs}^{cell}(nₛ,l) which has a value depending on a symbol number l and a slot number nₛ and is determined as n_{cs}^{cell}(nₛ,l)=Σᵢ₌₀⁷c(8N_{symb}^{UL}·nₛ+8l+i)·2ⁱ. Here, the pseudo-random sequence c(i) is initialized at the start of each radio frame according to cᵢₙᵢₜ=N_{ID}^{cell}.

As to PUCCH formats 2a and 2B, z(m) corresponds to d(10) when m=1, and z(m)=1 in other cases. For PUCCH formats 2a and 2b supported for only the normal CP, UCI bits b(20), . . . , b(M_{bit}−1) from among b(0), . . . , b(M_{bit}−1) are modulated into a single modulation symbol d(10) used to generate a reference signal for PUCCH formats 2a and 2b, as shown in Table 1.

TABLE 1

| PUCCH format | b(20), . . . , b(M_{bit} − 1) | d(10) |
|---|---|---|
| 2a | 0 | 1 |
| | 1 | −1 |
| 2b | 00 | 1 |
| | 01 | −j |
| | 10 | j |
| | 11 | −1 |

The PUSCH RS (referred to as PUSCH DMRS hereinafter) in FIG. 11 is transmitted on a layer basis. A PUSCH DMRS sequence r_{PUSCH}^{(p)}(·) related to layer λε{0, 1, . . . , u−1} is given by the following equation.

r_{PUSCH}^{(λ)}(m·M_{sc}^{RS}+n)=w^{(λ)}(m)r_{u,v}^{(α}^{_{—}}^{λ)}(n) [Equation 11]

Here, m=0,1, n=0, . . . , M_{sc}^{RS}−1, and M_{sc}^{RS}=M_{sc}^{PUSCH}. M_{sc}^{PUSCH} is a bandwidth scheduled for uplink transmission and denotes the number of subcarriers. An orthogonal sequence w^{(λ)}(m) can be given by Table 2 using a cyclic shift field in latest uplink-related DCI for transport blocks related to the corresponding PUSCH. Table 2 illustrates mapping of a cyclic shift field in an uplink-related DCI format to n_{DMRS,λ}⁽²⁾ and [w^{(λ)}(0) w^{(λ)}(1)].

TABLE 2

| Cyclic Shift Field in | | | | | | | | |
|---|---|---|---|---|---|---|---|---|
| uplink-related DCI | n_{DMRS, λ}⁽²⁾ | | | | [w^{(λ)}(0) w^{(λ)}(1)] | | | |
| format | λ = 0 | λ = 1 | λ = 2 | λ = 3 | λ = 0 | λ = 1 | λ = 2 | λ = 3 |
| 000 | 0 | 6 | 3 | 9 | [1 1] | [1 1] | [1 −1] | [1 −1] |
| 001 | 6 | 0 | 9 | 3 | [1 −1] | [1 −1] | [1 1] | [1 1] |
| 010 | 3 | 9 | 6 | 0 | [1 −1] | [1 −1] | [1 1] | [1 1] |
| 011 | 4 | 10 | 7 | 1 | [1 1] | [1 1] | [1 1] | [1 1] |
| 100 | 2 | 8 | 5 | 11 | [1 1] | [1 1] | [1 1] | [1 1] |
| 101 | 8 | 2 | 11 | 5 | [1 −1] | [1 −1] | [1 −1] | [1 −1] |
| 110 | 10 | 4 | 1 | 7 | [1 −1] | [1 −1] | [1 −1] | [1 −1] |
| 111 | 9 | 3 | 0 | 6 | [1 1] | [1 1] | [1 −1] | [1 −1] |

A cyclic shift α_λ in the slot nₛ is given as 2πn_{cs,λ}/12. Here, n_{cs,λ}=(n_{DMRS}⁽¹⁾+n_{DMRS,λ}⁽²⁾+n_{PN}(nₛ))mod 12 where n_{DMRS}⁽¹⁾ is given by Table 3 according to a cyclic shift parameter provided through higher layer signaling. Table 3 shows mapping of cyclic shifts to n_{DMRS}⁽¹⁾ according to higher layer signaling.

TABLE 3

| cyclicShift | n_{DMRS}⁽¹⁾ |
|---|---|
| 0 | 0 |
| 1 | 2 |
| 2 | 3 |
| 3 | 4 |
| 4 | 6 |
| 5 | 8 |
| 6 | 9 |
| 7 | 10 |

Furthermore, n_{PN}(nₛ) is given by the following equation using the cell-specific pseudo-random sequence c(i).

n_{PN}(nₛ)=Σᵢ₌₀⁷c(8N_{symb}^{UL}·nₛ+i)·2ⁱ [Equation 12]

Here, the pseudo-random sequence c(i) is defined by Equation 4. The pseudo-random sequence generator is initialized to cᵢₙᵢₜ at the start of each radio frame according to the following equation.

$${c}_{init} = ⌊ \frac{{N}_{ID}^{cell}}{30} ⌋ \cdot {2}^{5} + {f}_{ss}^{PUSCH} \qquad [ Equation 13 ]$$

An SRS sequence r_{SRS}^{(p)}(n)=r_{u,v}^{(α}^{_{—}}^{p)}(n) is defined by Equation 1. Here, u denotes the PUCCH sequence group number above-described with respect to group hopping and v denotes the base sequence number above-described with respect to sequence hopping. The cyclic shift α_p of the SRS is given as follows.

$${α}_{p} = 2 π \frac{{n}_{SRS}^{cs , p}}{8} \\ {n}_{SRS}^{cs , p} = ( {n}_{SRS}^{cs} + \frac{8 p}{{N}_{ap}} ) mod 8 \\ p ∈ \{ 0 , 1 , … , {N}_{ap} - 1 \} \qquad [ Equation 14 ]$$

Here, n_{SRS}^{cs}={0, 1, 2, 3, 4, 5, 6, 7} is a value configured for each UE by higher layer parameters and separately generated by different higher layer parameters for configurations of periodic sounding and non-periodic sounding. Nₐₚ denotes the number of antenna ports used for SRS transmission.

Coordinated Multi-Point: CoMP

CoMP transmission/reception scheme (which is also referred to as co-MIMO, collaborative MIMO or network MIMO) is proposed to meet enhanced system performance requirements of 3GPP LTE-A. CoMP can improve the performance of a UE located at a cell edge and increase average sector throughput.

In a multi-cell environment having a frequency reuse factor of 1, the performance of a UE located at a cell edge and average sector throughput may decrease due to inter-cell interference (ICI). To reduce ICI, a conventional LTE system uses a method for allowing a UE located at a cell edge in an interfered environment to have appropriate throughput using a simple passive scheme such as fractional frequency reuse (FFR) through UE-specific power control. However, it may be more preferable to reduce ICI or reuse ICI as a signal that a UE desires rather than decreasing frequency resource use per cell. To achieve this, CoMP can be applied.

CoMP applicable to downlink can be classified into joint processing (JP) and coordinated scheduling/beamforming (CS/CB).

According to the JP, each point (eNB) of a CoMP coordination unit can use data. The CoMP coordination unit refers to a set of eNBs used for a coordinated transmission scheme. The JP can be divided into joint transmission and dynamic cell selection.

The joint transmission refers to a scheme through which PDSCHs are simultaneously transmitted from a plurality of points (some or all CoMP coordination units). That is, data can be transmitted to a single UE from a plurality of transmission points. According to joint transmission, quality of a received signal can be improved coherently or non-coherently and interference on other UEs can be actively erased.

Dynamic cell selection refers to a scheme by which a PDSCH is transmitted from one point (in a CoMP coordination unit). That is, data is transmitted to a single UE from a single point at a specific time, other points in the coordination unit do not transmit data to the UE at the time, and the point that transmits the data to the UE can be dynamically selected.

According to the CS/CB scheme, CoMP coordination units can collaboratively perform beamforming of data transmission to a single UE. Here, user scheduling/beaming can be determined according to coordination of cells in a corresponding CoMP coordination unit although data is transmitted only from a serving cell.

In case of uplink, coordinated multi-point reception refers to reception of a signal transmitted according to coordination of a plurality of points geographically spaced apart from one another. A CoMP reception scheme applicable to uplink can be classified into joint reception (JR) and coordinated scheduling/beamforming (CS/CB).

JR is a scheme by which a plurality of reception points receives a signal transmitted over a PUSCH and CS/CB is a scheme by which user scheduling/beamforming is determined according to coordination of cells in a corresponding CoMP coordination unit while one point receives a PUSCH.

A UE can receive data from multi-cell base stations collaboratively using the CoMP system. The base stations can simultaneously support one or more UEs using the same radio frequency resource, improving system performance. Furthermore, a base station may perform space division multiple access (SDMA) on the basis of CSI between the base station and a UE.

In the CoMP system, a serving eNB and one or more collaborative eNBs are connected to a scheduler through a backbone network. The scheduler can operate by receiving channel information about a channel state between each UE and each collaborative eNB, measured by each eNB, through the backbone network. For example, the scheduler can schedule information for collaborative MIMO operation for the serving eNB and one or more collaborative eNBs. That is, the scheduler can directly direct collaborative MIMO operation to each eNB.

As described above, the CoMP system can be regarded as a virtual MIMO system using a group of a plurality of cells. Basically, a communication scheme of MIMO using multiple antennas can be applied to CoMP.

Enhanced Uplink Signal Transmission Scheme

Referring to Equations 1 to 14, UEs located in a cell initialize the pseudo-random sequence generator that generates RS sequences using the same N_{ID}^{cell}. Because a UE transmits an uplink signal only to one cell, the UE uses only one N_{ID}^{cell} in order to generate a PUSCH DMRS, PUCCH DMRS and SRS. That is, in a conventional system in which a UE transmits an uplink signal only to one cell, a UE based DMRS sequence is used. In other words, since the conventional communication system performs uplink transmission only for one cell, a UE can acquire N_{ID}^{cell} (i.e. physical layer cell ID) on the basis of a downlink PSS (Primary Synchronization Signal) received from the serving cell and use the acquired N_{ID}^{cell} to generate an uplink RS sequence.

However, in uplink CoMP, a UE can transmit an uplink signal to a plurality of cells or reception points (RPs) or to some of the cells or RPs. In this case, when an uplink transmitting side transmits an RS sequence generated according to a conventional method, a receiving side may not detect the RS.

Accordingly, for CoMP in which a plurality of cells or RPs participates in communication with a UE, it is necessary to define DMRS generation, resource allocation and/or transmission schemes for data transmitted to different points even if the different points do not simultaneously receive the data. While one RP can receive an uplink signal from a UE through one or more cells, a cell receiving an uplink signal is called an RP in the following description for convenience.

The present invention proposes a method by which a CoMP UE generates a DMRS sequence used for PUSCH transmission and/or PUCCH transmission in a multi-cell (multi-RP) environment.

FIG. 1 is a diagram for explaining an exemplary UL CoMP operation.

In an uplink CoMP operation by which one UE (i.e. CoMP UE) transmits a PUSCH to a plurality of cells (or RPs), it is important to ensure mutual orthogonality between uplink DMRSs. If mutual orthogonality between uplink DMRSs is not ensured, each RP cannot correctly estimate an uplink channel, and thus PUSCH demodulation performance is considerably deteriorated. The UE can generate a DMRS base sequence using the cell ID of a serving cell and apply an OCC for orthogonality with other DMRSs as necessary. Specifically, the uplink DMRS base sequence is a function of the cell ID, and a PUSCH DMRS base sequence index having an offset of Δₛₛ from a PUCCH DMRS base sequence index is determined. Here, Δₛₛ is given through higher layer signaling (e.g. RRC signaling). That is, the same cell ID is applied to generation of base sequences of PUCCH DMRS and PUSCH DMRS and a base sequence index offset of Δₛₛ is provided between the base sequences of PUCCH DMRS and PUSCH DMRS (refer to Equation 8). For example, if Δₛₛ=0 is signaled through RRC signaling, the PUCCH DMRS and PUSCH DMRS may have the same base sequence.

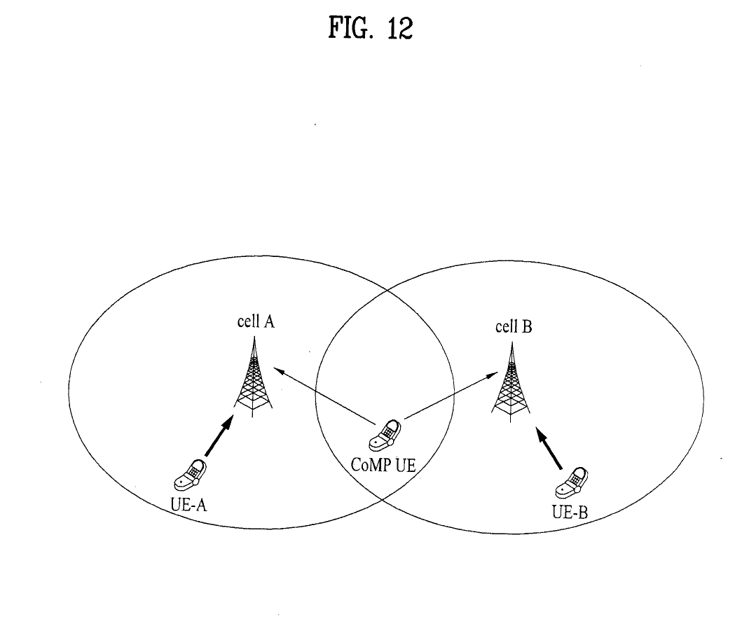

In case of the CoMP UE, a DL serving cell and a UL serving cell may be different from each other, and thus the cell ID of the DL serving cell cannot be used to generate a UL DMRS base sequence and the UL DMRS base sequence needs to be generated using the cell ID of an RP according to determination by a scheduler. That is, the UL DMRS base sequence needs to be generated using the ID of a cell other than the serving cell. To provide scheduling flexibility in determination of UEs paired for MU-MIMO, it is desirable to dynamically indicate a cell ID used to generate a UL DMRS. For example, a higher layer can signal setting of a plurality of DMRSs (including setting of a DMRS for cell A and setting of a DMRS for cell B) to a CoMP UE located at edges of a cell A and a cell B shown in FIG. 12. The CoMP UE may be co-scheduled with another UE (UE-A) of the cell A or another UE (UE-B) of the cell B according to channel condition and/or other network conditions. That is, a DMRS base sequence of the CoMP UE can be generated using the ID of a cell to which a UE co-scheduled with the CoMP UE belongs. The cell ID used for DMRS base sequence generation can be dynamically selected or indicated.

To support the above-described uplink CoMP operation, the present invention can provide a cell ID to be used to generate a PUSCH DMRS sequence to a UE through UE-specific higher layer signaling (e.g. RRC signaling). The cell ID used to generate the PUSCH DMRS sequence can be indicated using a parameter such as N_{ID}^{(PUSCH)} or n_{ID}^{(PUSCH)} to be discriminated from a cell ID (that is, a parameter N_{ID}^{cell} representing a physical layer cell ID (PCI)) used to generate a conventional DMRS sequence. Here, N_{ID}^{(PUSCH)} or n_{ID}^{(PUSCH)} may be called a virtual cell ID (VCI) for PUSCH DMRS sequence generation. The virtual cell ID (referred to as “PUSCH DMRS VCI”) for PUSCH DMRS sequence generation may have a value identical to or different from the PCI.

According to the conventional operation, a sequence shift pattern fₛₛ^{PUSCH} for the PUSCH DMRS is determined using a sequence shift pattern fₛₛ^{PUCCH} for the PUCCH and the sequence shift related offset Δₛₛ set by a higher layer (refer to Equations 7 and 8). When fₛₛ^{PUCCH} of Equation 7 is applied to Equation 8, the following equation 15 is obtained.

fₛₛ^{PUSCH}=((N_{ID}^{cell} mod 30)+Δₛₛ)mod 30=(N_{ID}^{cell}+Δₛₛ)mod 30 [Equation 15]

When use of the PUSCH DMRS VCI parameter (e.g. N_{ID}^{(PUSCH)} or n_{ID}^{(PUSCH)}) is set by a higher layer, the offset Δₛₛ set by the higher layer may be used in the present invention. This may be called a first scheme for setting Δₛₛ.

Furthermore, when use of the PUSCH DMRS VCI parameter (e.g. N_{ID}^{(PUSCH)} or n_{ID}^{(PUSCH)}) is set by the higher layer, the present invention may generate a PUSCH DMRS sequence using a predetermined (or pre-appointed) specific offset value Δₛₛ instead of the offset Δₛₛ set by the higher layer. That is, when the higher layer signals the PUSCH DMRS VCI parameter (e.g. N_{ID}^{(PUSCH)} or n_{ID}^{(PUSCH)}) to a UE, the UE can be configured to use the predetermined offset Δₛₛ, instead of the offset Δₛₛ previously used by the UE (or set by the higher layer). This may be called a second scheme for setting Δₛₛ.

As an example of the second scheme for setting Δₛₛ, the present invention may previously determine a rule such that operation is performed on the basis of Δₛₛ=0 when the higher layer sets use of the PUSCH DMRS VCI parameter N_{ID}^{(PUSCH)} or n_{ID}^{(PUSCH)}. This may be called a third scheme for setting Δₛₛ.

For example, the PUSCH DMRS VCI parameter N_{ID}^{(PUSCH)} or n_{ID}^{(PUSCH)} can replace the physical cell ID parameter N_{ID}^{cell} and Δₛₛ can be set to 0 in Equation 15. This is arranged as follows.

fₛₛ^{PUSCH}=N_{ID}^{(PUSCH)}mod 30 or

fₛₛ^{PUSCH}=n_{ID}^{(PUSCH)}mod 30 [Equation 16]

A plurality of PUSCH DMRS VCI values N_{ID}^{(PUSCH)} or n_{ID}^{(PUSCH)} may be set by the higher layer and a value to be used from among the plurality of PUSCH DMRS VCI values N_{ID}^{(PUSCH)} or n_{ID}^{(PUSCH)} may be dynamically indicated through uplink scheduling grant information (that is, uplink-related DCI). Here, when the PUSCH DMRS VCI values N_{ID}^{(PUSCH)} or n_{ID}^{(PUSCH)} are set by the higher layer, specific values Δₛₛ respectively mapped to the PUSCH DMRS VCI values may be used.

To dynamically indicate one of the PUSCH DMRS VCI values N_{ID}^{(PUSCH)} or n_{ID}^{(PUSCH)} through the uplink-related DCI, a bit (or bits) for indicating a virtual cell ID may be newly added to the uplink-related DCI format to explicitly indicate the corresponding VCI or an existing bit (or bits) may be reused. For example, a mapping relationship can be established such that one of states of a 3-bit “Carrier Indicator” field or a 3-bit “Cyclic Shift for DMRS and OCC index” field from among bit fields of the uplink-related DCI (e.g. DCI format 0 or 4) implicitly indicates one of the PUSCH DMRS VCI values N_{ID}^{(PUSCH)} or n_{ID}^{(PUSCH)}.

A case in which the PUSCH DMRS VCI N_{ID}^{(PUSCH)} or n_{ID}^{(PUSCH)} is set by the higher layer has been described in the above embodiment. The present invention proposes a scheme for setting/providing a virtual cell ID (referred to as “PUCCH DMRS VCI”) used to generate a PUCCH DMRS sequence through UE-specific higher layer signaling (e.g. RRC signaling). A PUCCH DMRS VCI parameter may be indicated by N_{ID}^{(PUSCH)} or n_{ID}^{(PUSCH)}.

While the same cell ID (i.e. physical cell ID parameter N_{ID}^{cell}) is used to generate a PUSCH DMRS sequence and a PUCCH DMRS sequence in conventional operations, the present invention proposes a scheme of separately (independently) setting the PUSCH DMRS VCI (that is, N_{ID}^{(PUSCH)} or n_{ID}^{(PUSCH)}) and the PUCCH DMRS VCI (that is, N_{ID}^{(PUCCH)} or n_{ID}^{(PUCCH)}).

For simplicity, the PUSCH DMRS VCI and the PUCCH DMRS VCI may be represented as one parameter n_{ID}^{RS}. In this case, n_{ID}^{RS} can be determined according to transmission type. That is, n_{ID}^{RS} can be defined as n_{ID}^{(PUSCH)} in case of PUSCH related transmission and n_{ID}^{RS} can be defined as n_{ID}^{(PUCCH)} in case of PUCCH related transmission. Here, while one parameter n_{ID}^{RS} is used, n_{ID}^{(PUSCH)} (or N_{ID}^{(PUSCH)}) and n_{ID}^{(PUCCH)} (or n_{ID}^{(PUCCH)}) are defined as separate parameters. That is, it should be understood that n_{ID}^{(PUSCH)} (or N_{ID}^{(PUSCH)}) and n_{ID}^{(PUCCH)} (or n_{ID}^{(PUCCH)}) can be set by a higher layer as separate parameters.

A case in which a PUCCH related VCI (that is, n_{ID}^{(PUCCH)} or N_{ID}^{(PUCCH)}) and a PUSCH related VCI (that is n_{ID}^{(PUSCH)} or N_{ID}^{(PUSCH)}) are different from each other may represent that a UE respectively transmits a PUCCH and a PUSCH to different RPs. That is, the PUCCH may be transmitted to an RP (or RPs) corresponding to n_{ID}^{(PUCCH)} or N_{ID}^{(PUCCH)} and the PUSCH may be transmitted to an RP (or RPs) corresponding to n_{ID}^{(PUSCH)} or N_{ID}^{(PUSCH)}.

A plurality of PUCCH DMRS VCI values N_{ID}^{(PUCCH)} or n_{ID}^{(PUCCH)} may be set by the higher layer and a value to be used from among the plurality of PUCCH DMRS VCI values N_{ID}^{(PUCCH)} or n_{ID}^{(PUCCH)} may be dynamically indicated through uplink-related DCI. To dynamically indicate one of the PUCCH DMRS VCI values, a method of implicitly indicating a PUCCH DMRS VCI through a state of a specific bit field of an uplink-related DCI format or a method of adding a new bit field (or bit fields) to explicitly indicate a PUCCH DMRS DCI may be used. For example, a mapping relationship can be established such that one of states of “HARQ process number” field (which is defined as 3 bits in case of FDD and 4 bits in case of TDD) of an uplink-related DCI format (e.g. DCI format 0 or 4) implicitly indicates one of the PUCCH DMRS VCI values. Otherwise, a mapping relationship can be established such that one of states of a bit field (e.g. downlink DMRS sequence generation can be performed using a scrambling ID value indicated by 3-bit “Antenna port(s), scrambling identity and number of layers” field), which indicates a downlink DMRS (or UE-specific RS) parameter in DCI (e.g. DCI format 2C) for downlink allocation, implicitly indicates one of the PUCCH DMRS VCI values.

The above-described embodiment of the present invention is represented by equations as follows.

When the pseudo-random sequence c(i) used to determine the group hopping pattern f_{gh}(nₛ) of an uplink DMRS is generated according to Equations 3 and 6, the present invention can initialize the pseudo-random sequence generator to cᵢₙᵢₜ at the start of each radio frame according to the following equation. That is, Equation 6 can be replaced by Equation 17.

$${c}_{init} = ⌊ \frac{{n}_{ID}^{RS}}{30} ⌋ \qquad [ Equation 17 ]$$

where n_{ID}^{RS}=n_{ID}^{(PUSCH)} or n_{ID}^{RS}=N_{ID}^{(PUSCH)} for a PUSCH, and n_{ID}^{RS}=n_{ID}^{(PUCCH)} or n_{ID}^{RS}=N_{ID}^{(PUCCH)} for a PUCCH.

Equation 17 may be represented as Equation 18.

$${c}_{init} = ⌊ \frac{{N}_{ID}^{( PUSCH )}}{30} ⌋ or {c}_{init} = ⌊ \frac{{n}_{ID}^{( PUSCH )}}{30} ⌋ for PUSCH , and \\ {c}_{init} = ⌊ \frac{{N}_{ID}^{( PUCCH )}}{30} ⌋ or {c}_{init} = ⌊ \frac{{n}_{ID}^{( PUCCH )}}{30} ⌋ for PUCCH \qquad [ Equation 18 ]$$

The sequence shift parameter fₛₛ^{PUCCH} for PUCCH DMRS can be represented by the following equation.

fₛₛ^{PUCCH}=n_{ID}^{RS} mod 30 [Equation 19]

where n_{ID}^{RS}=n_{ID}^{(PUCCH)} or n_{ID}^{RS}=N_{ID}^{(PUCCH)} for a PUCCH.

Equation 19 may be represented as Equation 20.

f_{SS}^{PUCCH}=N_{ID}^{(PUCCH)}mod 30 or f_{SS}^{PUCCH}=n_{ID}^{(PUCCH)}mod 30 [Equation 20]

When the sequence shift parameter fₛₛ^{PUSCH} for PUSCH DMRS is determined, fₛₛ^{PUSCH} can be represented by Equation 21 when Δₛₛ is predefined as 0 as represented by Equation 16.

fₛₛ^{PUSCH}=n_{ID}^{RS} mod 30 [Equation 21]

where n_{ID}^{RS}=n_{ID}^{(PUSCH)} or n_{ID}^{RS}=N_{ID}^{(PUSCH)} for a PUSCH.

Equation 21 may be represented as Equation 16 (that is, fₛₛ^{PUSCH}=N_{ID}^{(PUSCH)} mod 30 or fₛₛ^{PUSCH}=n_{ID}^{(PUSCH)} mod 30).

Here, it should be noted that n_{ID}^{(PUSCH)} (or N_{ID}^{(PUSCH)}) and n_{ID}^{(PUCCH)} (or n_{ID}^{(PUSCH)}), which are different from each other, are actually applied as VCI values (i.e. n_{ID}^{RS}) although fₛₛ^{PUCCH} and fₛₛ^{PUSCH} are defined in the same equation form in Equations 19 and 21.

When the scheme (the third scheme for setting Δₛₛ) represented by Equation 21 is applied, even if a value Δₛₛ set through higher layer signaling has been provided to a corresponding UE, fₛₛ^{PUSCH} is calculated by setting Δₛₛ to 0 when the PUSCH VCI (i.e. n_{ID}^{(PUSCH)} or N_{ID}^{(PUSCH)}) is set by higher layer signaling.

Alternatively, in determination of the sequence shift parameter fₛₛ^{PUSCH} for PUSCH DMRS, fₛₛ^{PUSCH} can be represented by Equation 22 when the value Δₛₛ set by the higher layer is used (that is, the first scheme for setting Δₛₛ) or a predetermined specific value Δₛₛ is used (that is, the second scheme for setting Δₛₛ).

f_{SS}^{PUSCH}={(n_{ID}^{RS} mod 30+Δ_{SS}} mod 30 [Equation 22]

where n_{ID}^{RS}=n_{ID}^{(PUSCH)} or n_{ID}^{RS}=N_{ID}^{(PUSCH)} for a PUSCH.

In Equation 22, Δₛₛε{0, 1, . . . , 29}.

Equation 22 may be represented as the following equation.

f_{SS}^{PUSCH}={(N_{ID}^{(PUSCH)}mod 30)+Δ_{SS}} mod 30

or

f_{SS}^{PUSCH}={(n_{ID}^{(PUSCH)}mod 30)+Δ_{SS}} mod 30 [Equation 23]

According to the first scheme for setting Δₛₛ, fₛₛ^{PUSCH} can be calculated using the value Δₛₛ set by higher layer signaling and previously provided to the corresponding UE and the PUSCH VCI (that is, n_{ID}^{(PUSCH)} or N_{ID}^{(PUSCH)}) signaled by the higher layer.

According to the second scheme for setting Δₛₛ, even if the value Δₛₛ set by higher layer signaling has been provided to the corresponding UE, fₛₛ^{PUSCH} can be calculated by setting Δₛₛ to a specific value s (sε{0, 1, . . . , 29}) when the PUSCH VCI (that is, n_{ID}^{(PUSCH)} or N_{ID}^{(PUSCH)}) is set through higher layer signaling.

According to the above-described embodiments, a group hopping pattern f_{gh}(nₛ) of a UE for which a value A is set by a higher layer as a PUSCH DMRS VCI (that is, n_{ID}^{(PUSCH)} or N_{ID}^{(PUSCH)}) corresponds to group hopping patterns of other UEs (that is, UEs for which a PCI is set to A and/or UEs for which a PUSCH VCI is set to A) using the value A as a cell ID. Furthermore, when the same Δₛₛ (particularly, Δₛₛ=0) is applied to determination of the sequence shift pattern fₛₛ^{PUSCH}, the sequence shift pattern of the UE for which the PUSCH VCI is set corresponds to PUSCH DMRS sequence shift patterns of the other UEs. Accordingly, base sequence indexes u of UEs which use the same group hopping pattern and the same sequence shift pattern are identical (refer to Equation 2). This means that orthogonality can be given between DMRSs of the UEs by respectively applying different CSs to the UEs. That is, the present invention can provide orthogonality between PUSCH DMRSs of UEs belonging to different cells by setting a PUSCH DMRS VCI for a specific UE, distinguished from a conventional wireless communication system in which orthogonality between PUSCH DMRSs is given using different CSs in the same cell. Accordingly, MU-MIMO pairing for UEs belonging to different cells can be achieved and enhanced UL CoMP operation can be supported.

Furthermore, even when different PUSCH DMRS VCI values are set for a plurality of UEs, orthogonality between PUSCH DMRSs can be provided by making the plurality or UEs use the same PUSCH DMRS base sequence.

Specifically, the first, second and third schemes for setting Δₛₛ correspond to a rule of determining a value Δₛₛ to be used when the PUSCH DMRS VCI (that is, n_{ID}^{(PUSCH)} or N_{ID}^{(PUSCH)}) is signaled by a higher layer. On the assumption that one of the schemes is applied, an eNB can select an appropriate PUSCH DMRS VCI (that is, n_{ID}^{(PUSCH)} or N_{ID}^{(PUSCH)}) in consideration of a value Δₛₛ to be used and signal the selected PUSCH DMRS VCI to a UE. Here, cᵢₙᵢₜ, which is a factor (or a seed value) for determining the group hopping pattern f_{gh}(nₛ), is determined as the same value for 30 different VCI values (that is, n_{ID}^{(PUSCH)} or N_{ID}^{(PUSCH)} according to a floor operation as represented by Equations 17 and 18. Accordingly, it is possible to set fₛₛ^{PUSCH} to a specific value by selecting an appropriate one of the 30 different VCI values generating the same group hopping pattern f_{gh}(nₛ). That is, group hopping patterns f_{gh}(nₛ) respectively calculated by two different UEs can be identical to each other even though different VCIs are set for the two UEs. Furthermore, sequence shift patterns fₛₛ^{PUSCH} respectively calculated by the two UEs can be identical to each other. An appropriate VCI (that is, n_{ID}^{(PUSCH)} or N_{ID}^{(PUSCH)}) that makes group hopping patterns f_{gh}(nₛ) and sequence shift patterns fₛₛ^{PUSCH} of MU-MIMO-paired UEs correspond to each other can be set through a higher layer. Accordingly, PUSCH DMRS base sequences of the UEs become identical, and thus orthogonality between PUSCH DMRSs can be provided according to a method of applying different CSs to the UEs.

In addition, a plurality of UEs can have the same group hopping pattern f_{gh}(nₛ) and/or the same sequence shift pattern fₛₛ^{PUSCH} through a method of setting a UE-specific VCI (that is, n_{ID}^{(PUSCH)} or N_{ID}^{(PUSCH)}) and/or a method of setting a UE-specific Δₛₛ. Here, since a method of additionally higher-layer-signaling a value Δₛₛ to each UE may generate unnecessary overhead, it is possible to make the UEs have the same group hopping pattern f_{gh}(nₛ) and the same sequence shift pattern fₛₛ^{PUSCH} by signaling only the UE-specific VCI without separately signaling Δₛₛ.

Alternatively, the PUSCH transmission related VCI (that is, n_{ID}^{(PUSCH)} or N_{ID}^{(PUSCH)}) may be used only when fₛₛ^{PUSCH} is determined. That is, the PCI (that is, N_{ID}^{cell}) of the current serving cell is used for fₛₛ^{PUCCH}, as represented by Equation 7, and the VCI (that is, n_{ID}^{(PUSCH)} or N_{ID}^{(PUSCH)}) proposed by the present invention is used for fₛₛ^{PUSCH} to separate a PUCCH sequence and a PUSCH sequence from each other.

Alternatively, N_{ID}^{(PUSCH)} may also be applied to fₛₛ^{PUCCH}. That is, fₛₛ^{PUCCH} can be defined by Equation 24.

fₛₛ^{PUCCH}=N_{ID}^{(PUSCH)}mod 30 or f_{SS}^{PUCCH}=n_{ID}^{(PUSCH)}mod 30 [Equation 24]

Equation 24 represents that a UE-specific VCI (N_{ID}) is set by higher layer signaling and commonly used to determine fₛₛ^{PUCCH} and fₛₛ^{PUSCH}. That is, a PUCCH and a PUSCH are transmitted from a corresponding UE to an RP (or RPs) using a UE-specific N_{ID} by setting the UE-specific N_{ID}.

The scope of the present invention is not limited to the above-described embodiments and can include various methods for allowing UEs to have the same PUSCH DMRS sequence group hopping pattern f_{gh}(nₛ) and/or the same shift pattern fₛₛ^{PUSCH} by setting a UE-specific VCI.

When group hopping is disabled and sequence hopping is enabled, sequence hopping according to a conventional method can be defined as represented by Equation 9. As proposed by the present invention, when a UE-specific VCI (that is, n_{ID}^{(PUSCH)} or N_{ID}^{(PUSCH)}) is set by a higher layer and sequence hopping is enabled, the pseudo-random sequence generator can be initialized to cᵢₙᵢₜ at the start of each radio frame according to the following equation.

$${c}_{init} = ⌊ \frac{{n}_{ID}^{RS}}{30} ⌋ \cdot {2}^{5} + {f}_{ss}^{PUSCH} \qquad [ Equation 25 ]$$

where n_{ID}^{RS}=n_{ID}^{(PUSCH)} or n_{ID}^{RS}=N_{ID}^{(PUSCH)} for a PUSCH.

The VCI (that is, n_{ID}^{RS} (n_{ID}^{RS}=n_{ID}^{(PUSCH)} or n_{ID}^{RS}=N_{ID}^{(PUSCH)} for PUSCH transmission)) used in Equation 25 may correspond to the PUSCH DMRS VCI signaled to the UE through higher layer signaling, which is described in the other embodiments. In addition, fₛₛ^{PUSCH} Equation 25 may correspond to the value determined according to Equation 16, 21, 22 or 23 (that is, a value determined according to the first, second or third scheme for setting Δₛₛ)

Specifically, n_{ID}^{RS} and fₛₛ^{PUSCH} in Equation 25 can use the same values as n_{ID}^{RS} and fₛₛ^{PUSCH} determined to make group hopping patterns f_{gh}(nₛ) and sequence hopping patterns fₛₛ^{PUSCH} set for MU-MIMO-paired UE equal to each other when the third scheme (that is, a scheme of determining Δₛₛ as 0 without additional higher layer signaling for setting Δₛₛ) for setting Δₛₛ is applied.

While operations capable of efficiently supporting CoMP operation using an uplink DMRS have been described above, the scope of the present invention is not limited thereto and the principle of the present invention can be equally applied to other uplink RS transmission/reception schemes.

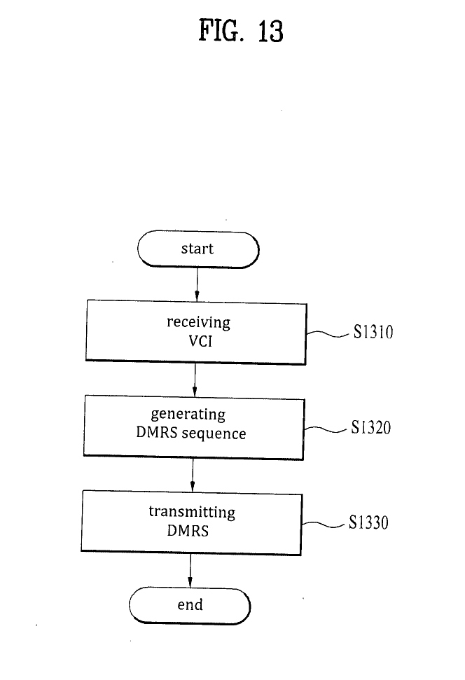

FIG. 13 is a flowchart illustrating a method for transmitting an uplink DMRS according to an embodiment of the present invention.

A UE may receive a VCI (e.g. n_{ID}^{RS}) from an eNB through higher layer signaling (e.g. RRC signaling) in step S1310. Here, a first VCI (e.g. n_{ID}^{PUCCH}) for a PUCCH DMRS and a second VCI (e.g. n_{ID}^{PUSCH}) for a PUSCH DMRS may be signaled/set as separate parameters (that is, independent parameters).

The UE may generate an RS sequence (e.g. a PUCCH DMRS sequence and/or a PUSCH DMRS sequence) in step S1320. The embodiments of the present invention may be applied to DMRS sequence generation. For example, when the VCI is set by a higher layer, a group hopping pattern, a sequence shift pattern, sequence hopping and/or CS hopping can be determined according to the embodiments of the present invention, and the DMRS sequence can be generated according to the determined group hopping pattern, sequence shift pattern, sequence hopping and/or CS hopping. If the VCI is not set by the higher layer, the PUCCH DMRS sequence and/or the PUSCH DMRS sequence can be generated using a PCI as in a conventional wireless communication system. The above-described embodiments of the present invention may be independently applied or two or more embodiments may be simultaneously applied, and redundant descriptions are avoided for clarity.

The UE may map the generated DMRS sequence to an uplink resource and transmit the DMRS sequence to the eNB in step S1330. The positions of REs mapped to the PUSCH DMRS sequence and the positions of REs mapped to the PUCCH DMRS sequence are as described with reference to FIGS. 5 to 10.

When the eNB receives an uplink RS transmitted from the UE, the eNB can detect the uplink RS on the assumption that the UE generates the uplink RS according to the RS sequence generation scheme proposed by the present invention.

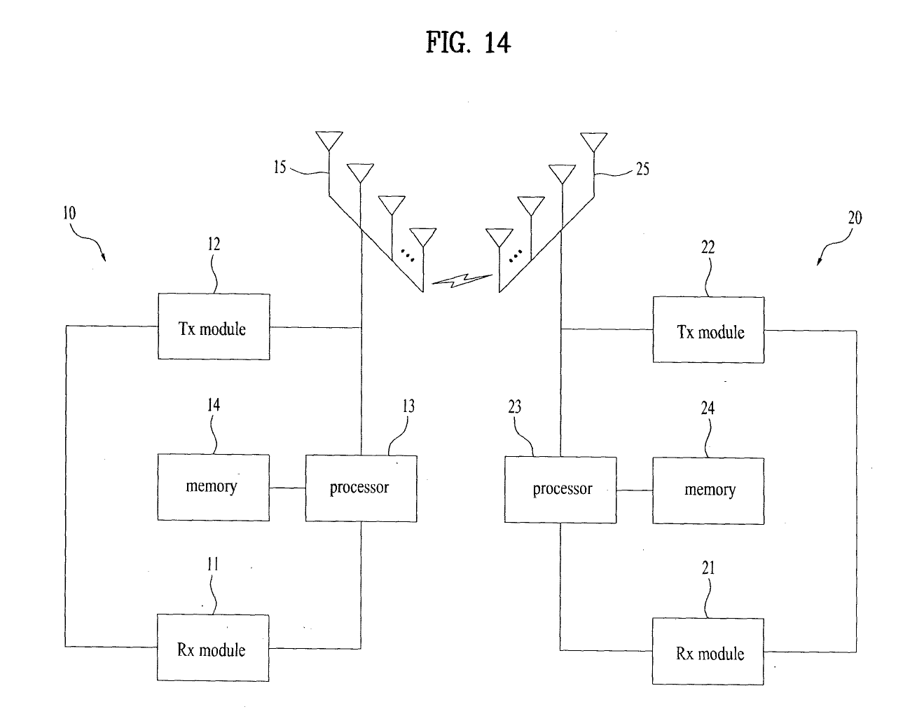

FIG. 14 illustrates a configuration of a UE device according to an embodiment of the present invention.

Referring to FIG. 14, a UE device 10 according to an embodiment of the present invention may include a transmitter 11, a receiver 12, a processor 13, a memory 14 and a plurality of antennas 15. The plurality of antennas 15 means that the UE device supports MIMO transmission and reception. The transmitter 11 can transmit signals, data and information to an external device (e.g. eNB). The receiver 12 can receive signals, data and information from an external device (e.g. eNB). The processor 13 can control the overall operation of the UE device 10.

The UE device 10 according to an embodiment of the present invention can be configured to transmit an uplink signal.

RS

The processor 12 of the UE device 10 can receive a VCI (e.g. n_{ID}^{RS}) using the receiver 11 from an eNB through higher layer signaling (e.g. RRC signaling). Here, a VCI (e.g. n_{ID}^{PUCCH}) for a PUCCH DMRS and a VCI (e.g. n_{ID}^{PUSCH}) for a PUSCH DMRS may be independently signaled/set.

The processor 13 of the UE device 10 can be configured to generate an RS sequence (e.g. a PUCCH DMRS sequence and/or a PUSCH DMRS sequence). The embodiments of the present invention may be applied to DMRS sequence generation. For example, when the VCI is set by a higher layer, the processor 13 can determine a group hopping pattern, a sequence shift pattern, sequence hopping and/or CS hopping according to the embodiments of the present invention and generate the DMRS sequence according to the determined group hopping pattern, sequence shift pattern, sequence hopping and/or CS hopping. Alternatively, a group hopping pattern, a sequence shift pattern, sequence hopping and/or CS hopping, which can be generated for each VCI, can be previously generated as a table and appropriate values can be detected from the table according to a set VCI. If the VCI is not set by the higher layer, the PUCCH DMRS sequence and/or the PUSCH DMRS sequence may be generated using a PCI as in a conventional wireless communication system.

The processor 13 of the UE device 10 can map the generated DMRS sequence to an uplink resource and transmit the DMRS sequence to the eNB using the transmitter 12. The positions of REs mapped to the PUSCH DMRS sequence and the positions of REs mapped to the PUCCH DMRS sequence are as described with reference to FIGS. 5 to 10.

In addition, the processor 13 of the UE device 10 processes information received by the UE device 10, information to be transmitted to an external device, etc. The memory 14 can store the processed information for a predetermined time and can be replaced by a component such as a buffer (not shown).

The UE device 10 may be implemented such that the above-described embodiments of the present invention can be independently applied or two or more embodiments can be simultaneously applied, and redundant descriptions are avoided for clarity.

An eNB device according to an embodiment of the present invention can include a transmitter, a receiver, a processor, a memory and antennas. When the processor of the eNB device receives an uplink RS transmitted from the UE device 10, the processor of the eNB device can be configured to detect the uplink RS on the assumption that the UE device 10 generates the uplink RS according to the RS sequence generation scheme proposed by the present invention.

While an eNB is exemplified as a downlink transmission entity or an uplink reception entity and a UE is exemplified as a downlink reception entity or an uplink transmission entity in the embodiments of the present invention, the scope of the present invention is not limited thereto. For example, description of the eNB can be equally applied to a case in which a cell, an antenna port, an antenna port group, an RRH, a transmission point, a reception point, an access point or a relay node serves as an entity of downlink transmission to a UE or an entity of uplink reception from the UE. Furthermore, the principle of the present invention described through the various embodiment of the present invention can be equally applied to a case in which a relay node serves as an entity of downlink transmission to a UE or an entity of uplink reception from the UE or a case in which a relay node serves as an entity of uplink transmission to an eNB or an entity of downlink reception from the eNB.

The embodiments of the present invention may be implemented by various means, for example, hardware, firmware, software, or combinations thereof.

When the embodiments of the present invention are implemented using hardware, the embodiments may be implemented using at least one of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, the embodiments of the present invention may be implemented in the form of a module, a procedure, a function, etc. For example, software code may be stored in a memory unit and executed by a processor. The memory unit is located at the interior or exterior of the processor and may transmit and receive data to and from the processor via various known means.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

It is obvious to those skilled in the art that claims that are not explicitly cited in each other in the appended claims may be presented in combination as an exemplary embodiment of the present invention or included as a new claim by subsequent amendment after the application is filed.

### INDUSTRIAL APPLICABILITY

The above-described embodiments of the present invention can be applied to various mobile communication systems.

1. A method for transmitting an uplink signal at a user equipment (UE) in a wireless communication system, the method comprising:
when a virtual cell ID n_{ID}^{PUSCH} for a reference signal for demodulation of a physical uplink shared channel (PUSCH) is provided, generating a sequence of the reference signal on the basis of n_{ID}^{PUSCH}; and
transmitting the generated reference signal to an eNB,
wherein a sequence shift pattern fₛₛ^{PUSCH} of the reference signal is determined according to fₛₛ^{PUSCH}=n_{ID}^{PUSCH} mod 30,
wherein mod denotes a modulo operation.

2. The method according to claim 1, wherein, when n_{ID}^{PUSCH} is not provided, fₛₛ^{PUSCH} is determined according to fₛₛ^{PUSCH}=(N_{ID}^{cell}+Δₛₛ)mod 30,
wherein N_{ID}^{cell} is a physical layer cell ID, Δₛₛ is set by a higher layer, and Δₛₛε{0, 1, . . . , 29}.

3. The method according to claim 1, wherein, when n_{ID}^{PUSCH} is provided and sequence group hopping for the reference signal is enabled, a pseudo-random sequence generator used to determine a group hopping pattern f_{gh}(nₛ) is initialized according to
$${c}_{init} = ⌊ \frac{{n}_{ID}^{PUSCH}}{30} ⌋$$
at the start of each radio frame,
wherein nₛ is a slot number and cᵢₙᵢₜ is an initial value of a pseudo-random sequence.

4. The method according to claim 3, wherein a sequence group number u of the reference signal is determined according to an equation of u=(f_{gh}(nₛ)+fₛₛ^{PUSCH})mod 30 with respect to the group hopping pattern f_{gh}(nₛ) and the sequence shift pattern fₛₛ^{PUSCH}.

5. The method according to claim 4, wherein uε{0, 1, . . . , 29}.

6. The method according to claim 1, wherein, when n_{ID}^{PUSCH} is provided, sequence group hopping for the reference signal is disabled and sequence hopping is enabled, a pseudo-random sequence generator used to determine a base sequence number v is initialized according to
$${c}_{init} = ⌊ \frac{{n}_{ID}^{PUSCH}}{30} ⌋ \cdot {2}^{5} + {f}_{ss}^{PUSCH}$$
at the start of each radio frame,
wherein cᵢₙᵢₜ is an initial value of a pseudo-random sequence.

7. The method according to claim 1, wherein n_{ID}^{PUSCH} is provided by a higher layer.

8. The method according to claim 1, wherein n_{ID}^{PUSCH} is set to a value making the group hopping pattern of the reference signal for the UE identical to a group hopping pattern for other UE which is MU-MIMO (Multi-User-Multiple Input Multiple Output)-paired with the UE.

9. The method according to claim 1, wherein n_{ID}^{PUSCH} is set to a value making the sequence shift pattern of the reference signal for the UE identical to a sequence shift pattern for other UE which is MU-MIMO-paired with the UE.

10. The method according to claim 1, wherein the reference signal is transmitted on an SC-FDMA (Single Carrier Frequency Division Multiple Access) symbol in a slot in which the PUSCH is transmitted.

11. A UE device for transmitting an uplink signal, comprising:
a receiver;
a transmitter; and
a processor,
wherein, when a virtual cell ID n_{ID}^{PUSCH} for a reference signal for demodulation of a PUSCH is provided, the processor is configured to generate a sequence of the reference signal on the basis of n_{ID}^{PUSCH} and to transmit the generated reference signal to an eNB through the transmitter,
wherein a sequence shift pattern fₛₛ^{PUSCH} of the reference signal is determined according to fₛₛ^{PUSCH}=n_{ID}^{PUSCH} mod 30,
wherein mod denotes a modulo operation.
